(19) United States
(12) Patent Application Publication
(10) Pub. No.: US 2023/0103606 A1
(43) Pub. Date: Apr. 6, 2023

(54) METHOD OF TRANSMITTING OR RECEIVING CONTROL CHANNELS FOR COMMUNICATION SYSTEM OPERATING IN HIGH FREQUENCY BAND, AND APPARATUS THEREFOR

(71) Applicant: ELECTRONICS AND TELECOMMUNICATIONS RESEARCH INSTITUTE, Daejeon (KR)

(72) Inventors: Jung Hoon LEE, Daejeon (KR); Cheul Soon KIM, Daejeon (KR); Sung Hyun MOON, Daejeon (KR)

(73) Assignee: ELECTRONICS AND TELECOMMUNICATIONS RESEARCH INSTITUTE, Daejeon (KR)

(21) Appl. No.: 17/953,968

(22) Filed: Sep. 27, 2022

(30) Foreign Application Priority Data
Sep. 27, 2021 (KR) 10-2021-0127509
Nov. 1, 2021 (KR) 10-2021-0148289
Jan. 11, 2022 (KR) 10-2022-0004309
Jan. 18, 2022 (KR) 10-2022-0007377
Feb. 14, 2022 (KR) 10-2022-0019122

(51) Int. Cl. H04W 24/08; H04W 72/04

(52) U.S. Cl. CPC H04W 24/08; H04W 72/042; H04W 72/0446

(57) ABSTRACT

A control channel reception method performed by a terminal may comprise: reporting, to a base station, information on at least one slot span combination supportable by the terminal for PDCCH monitoring; identifying PDCCH occasion(s) for PDCCH(s) to be transmitted from the base station based on the at least one slot span combination supportable by the terminal; and performing PDCCH monitoring in the identified PDCCH occasion(s).

### CROSS-REFERENCE TO RELATED APPLICATIONS

This application claims priority to Korean Patent Applications No. 10-2021-0127509 filed on Sep. 27, 2021, No. 10-2021-0148289 filed on Nov. 1, 2021, No. 10-2022-0004309 filed on Jan. 11, 2022, No. 10-2022-0007377 filed on Jan. 18, 2022, and No. 10-2022-0019122 filed on Feb. 14, 2022 with the Korean Intellectual Property Office (KIPO), the entire contents of which are hereby incorporated by reference.

### BACKGROUND

### 1. Technical Field

The present disclosure relates to a method and an apparatus for transmitting or receiving control channels in a new radio (NR) system, and more particularly, to a method for transmitting or receiving/monitoring physical downlink control channels (PDCCHs) for an NR system operating in a high frequency band (e.g., frequency band above 52.6 GHz).

### 2. Related Art

In order to reduce complexity and power consumption of a terminal in the NR system, the number of PDCCH candidates in which the terminal can attempt to detect PDCCHs in a PDCCH monitoring process may be limited by PDCCH blind decoding capability and channel estimation capability of the terminal. Meanwhile, in the NR release-17, a discussion has begun to support operations of the NR system in a frequency band of 52.6 GHz or above (e.g., 52.6 GHz to 71 GHz (i.e., FR2-2 band)) by extending the existing 24.25 GHz to 52.6 GHz frequency band (i.e., FR2-1 band). As the frequency band increases, support of larger subcarrier spacings for more robust operations to frequency offset errors and phase noises has been discussed. In addition to 60 kHz and 120 kHz subcarrier spacings used in the existing FR2 band, 480 kHz and 960 kHz subcarrier spacings may be applied for initial access and data transmission/reception, and designs of physical layer signals and channels, and physical layer procedures are also being discussed in accordance with the support of larger subcarrier spacings. When PDCCH monitoring is performed in slots configured with a large subcarrier spacing, the complexity and power consumption of the terminal may significantly increase. Therefore, the present disclosure proposes methods for improving PDCCH transmission and monitoring/reception according to the introduction of the new subcarrier spacings.

### SUMMARY

Accordingly, exemplary embodiments of the present disclosure are directed to providing control channel transmitting methods and control channel monitoring/receiving methods for an NR system operating in a high frequency band.

Accordingly, exemplary embodiments of the present disclosure are also directed to providing configurations of apparatuses for performing the control channel transmission methods and/or control channel monitoring/receiving methods.

According to a first exemplary embodiment of the present disclosure, a control channel reception method performed by a terminal may comprise: reporting, to a base station, information on at least one slot span combination supportable by the terminal for PDCCH monitoring; identifying PDCCH occasion(s) for PDCCH(s) to be transmitted from the base station based on the at least one slot span combination supportable by the terminal; and performing PDCCH monitoring in the identified PDCCH occasion(s).

The information on at least one slot span combination supportable by the terminal for PDCCH monitoring may be reported for each of subcarrier spacings supported by the terminal.

When the terminal operates in a frequency band of 52.6 GHz or above, the sub-carrier spacings may include 480 kHz and 960 kHz subcarrier spacings.

Each of the at least one slot span combination may be indicated by (X, Y), X may indicate a number of slot(s) constituting one slot span, and Y may indicate a number of PDCCH monitoring slot(s) included in one slot span.

Each of the at least one slot span combination may be indicated by (X, Y), X may indicate a number of slot(s) constituting one slot span, and Y may be determined based on a number of PDCCH monitoring slot(s) for a group 1 search space (SS) and/or a number of PDCCH monitoring slot(s) for a group 2 search space (SS), the group 1 SS and the group 2 SS being included in the one slot span.

A position of the PDCCH monitoring slot(s) for the group 2 SS may be determined based on a synchronization signal block (SSB) index or an SSB candidate index of an SSB that the terminal receives from the base station.

When the PDCCH monitoring slot(s) for the group 2 SS are two slots, a position of a first slot among the two slots may be determined based on the SSB index or the SSB candidate index, and a position of a second slot among the two slots may be determined by applying a predetermined offset to the position of the first slot.

The control channel reception method may further comprise receiving a first parameter and a second parameter from the base station, wherein the first parameter may be a bitmap indicating the PDCCH monitoring slot(s) among the slot(s) constituting the one slot span, and the second parameter may be a bitmap indicating positions(s) of symbol(s) from which a search space starts in each of the PDCCH monitoring slot(s).

Each of the at least one slot span combination may be applied to all types of slot(s) regardless of uplink (UL)/downlink (DL) configuration, or applied to slot(s) having DL symbols and/or flexible symbols equal to or more than a specific threshold.

According to a second exemplary embodiment of the present disclosure, a control channel transmission method performed by a base station may comprise: receiving, from a terminal, information on at least one slot span combination supportable by the terminal for PDCCH monitoring; configuring PDCCH occasion(s) for PDCCH(s) to be transmitted to the terminal based on the at least one slot span combination supportable by the terminal; and transmitting PDCCH(s) in the configured PDCCH occasion(s).

The information on at least one slot span combination supportable by the terminal for PDCCH monitoring may be reported for each of subcarrier spacings supported by the terminal.

When the terminal operates in a frequency band of 52.6 GHz or above, the sub-carrier spacings may include 480 kHz and 960 kHz subcarrier spacings.

Each of the at least one slot span combination may be indicated by (X, Y), X may indicate a number of slot(s) constituting one slot span, and Y may indicate a number of PDCCH monitoring slot(s) included in one slot span.

Each of the at least one slot span combination may be indicated by (X, Y), X may indicate a number of slot(s) constituting one slot span, and Y may be determined based on a number of PDCCH monitoring slot(s) for a group 1 search space (SS) and/or a number of PDCCH monitoring slot(s) for a group 2 search space (SS), the group 1 SS and the group 2 SS being included in the one slot span.

A position of the PDCCH monitoring slot(s) for the group 2 SS may be determined based on a synchronization signal block (SSB) index or an SSB candidate index of an SSB that the base station transmits to the terminal.

When the PDCCH monitoring slot(s) for the group 2 SS are two slots, a position of a first slot among the two slots may be determined based on the SSB index or the SSB candidate index, and a position of a second slot among the two slots may be determined by applying a predetermined offset to the position of the first slot.

The control channel transmission method may further comprise transmitting a first parameter and a second parameter to the terminal, wherein the first parameter may be a bitmap indicating the PDCCH monitoring slot(s) among the slot(s) constituting the one slot span, and the second parameter may be a bitmap indicating positions(s) of symbol(s) from which a search space starts in each of the PDCCH monitoring slot(s).

Each of the at least one slot span combination may be applied to all types of slot(s) regardless of uplink (UL)/downlink (DL) configuration, or applied to slot(s) having DL symbols and/or flexible symbols equal to or more than a specific threshold.

According to a third exemplary embodiment of the present disclosure, a terminal in a communication system may comprise: a processor; and a transceiver controlled by the processor, wherein the processor causes the terminal to: report, to a base station and through the transceiver, information on at least one slot span combination supportable by the terminal for PDCCH monitoring; identify PDCCH occasion(s) for PDCCH(s) to be transmitted from the base station based on the at least one slot span combination supportable by the terminal; and perform PDCCH monitoring by using the transceiver in the identified PDCCH occasion(s).

The information on at least one slot span combination supportable by the terminal for PDCCH monitoring may be reported for each of subcarrier spacings supported by the terminal, and when the terminal operates in a frequency band of 52.6 GHz or above, the sub-carrier spacings may include 480 kHz and 960 kHz subcarrier spacings.

According to exemplary embodiments of the present disclosure, in the NR system operating in a high frequency band of 52.6 GHz or above (e.g., 52.6 GHz to 71 GHz (i.e., FR2-2 band)), transmission, monitoring, and reception of control channels can be performed efficiently.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of a type 1 frame.

FIG. 4 is a conceptual diagram illustrating a first exemplary embodiment of a type 2 frame.

FIG. 5 is a conceptual diagram illustrating a first exemplary embodiment of a transmission method of SS/PBCH block in a communication system.

FIG. 6 is a conceptual diagram illustrating a first exemplary embodiment of an SS/PBCH block in a communication system.

FIG. 7 is a conceptual diagram illustrating a second exemplary embodiment of a method of transmitting SS/PBCH blocks in a communication system.

FIG. 8A is a conceptual diagram illustrating an RMSI CORESET mapping pattern #1 in a communication system, FIG. 8B is a conceptual diagram illustrating an RMSI CORESET mapping pattern #2 in a communication system, and FIG. 8C is a conceptual diagram illustrating an RMSI CORESET mapping pattern #3 in a communication system.

FIGS. 9A to 9C are diagrams for describing examples of various configurations of Type 0 CSS slots corresponding to SSB indexes.

FIG. 10 is a conceptual diagram illustrating exemplary embodiments of a method for multiplexing a control channel and a data channel in sidelink communication.

FIG. 11 is a conceptual diagram for describing a span combination (X=4, Y=3) for PDCCH monitoring.

FIG. 12 is a conceptual diagram illustrating an example of configuring PDCCH monitoring slots according to a slot span combination (X=4, Y=2) for PDCCH monitoring.

FIG. 13 is a conceptual diagram illustrating an example of configuring PDCCH monitoring slots according to a slot span combination (X=4, Y=2, Z=1) for PDCCH monitoring.

FIG. 14 is a conceptual diagram illustrating another example of configuring PDCCH monitoring slots according to a slot span combination (X=4, Y=2, Z=1) for PDCCH monitoring.

FIGS. 15A to 15C are diagrams for describing examples of configuring a position of Y_{Group1} slot(s) by applying an offset to a position of Y_{Group}2 slot(s).

FIG. 16 is a conceptual diagram illustrating a first exemplary embodiment of configuring Y_{Group2} slots for Type 0 CSS.

FIG. 17 is a conceptual diagram illustrating a second exemplary embodiment of configuring Y_{Group2} slots for Type 0 CSS.

FIG. 18 is a conceptual diagram illustrating a third exemplary embodiment of configuring Y_{Group2} slots for Type 0 CSS.

FIG. 19 is a conceptual diagram illustrating a fourth exemplary embodiment of configuring Y_{Group2} slots for Type 0 CSS.

FIG. 20 is a conceptual diagram illustrating a fifth exemplary embodiment of configuring Y_{Group2} slots for Type 0 CSS.

FIGS. 21A and 21B are conceptual diagrams for describing examples of TDD UL/DL configuration of the NR system.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, ‘at least one of A and B’ may mean ‘at least one of A or B’ or ‘at least one of combinations of one or more of A and B’. Also, in exemplary embodiments of the present disclosure, ‘one or more of A and B’ may mean ‘one or more of A or B’ or ‘one or more of combinations of one or more of A and B’.

In exemplary embodiments of the present disclosure, ‘(re)transmission’ may mean ‘transmission’, ‘retransmission’, or ‘transmission and retransmission’, ‘(re)configuration’ may mean ‘configuration’, ‘reconfiguration’, or ‘configuration and reconfiguration’, ‘(re)connection’ may mean ‘connection’, ‘reconnection’, or ‘connection and reconnection’, and ‘(re-)access’ may mean ‘access’, ‘re-access’, or ‘access and re-access’.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

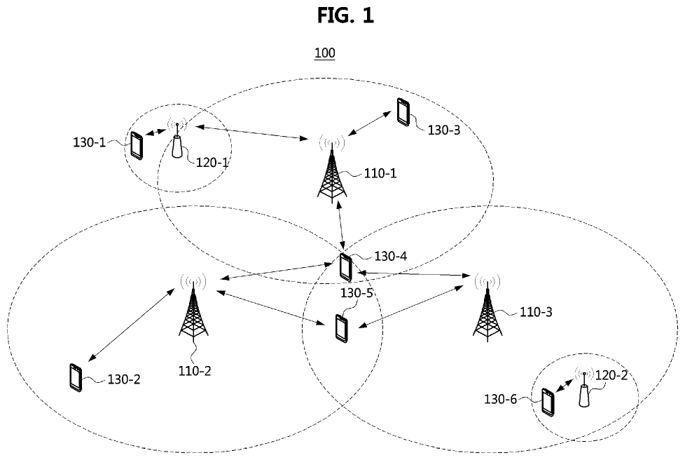

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g., a serving gateway (S-GW), a packet data network (PDN) gateway (P-GW), and a mobility management entity (MME)). When the communication system 100 is a 5G communication system (e.g., new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g., LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

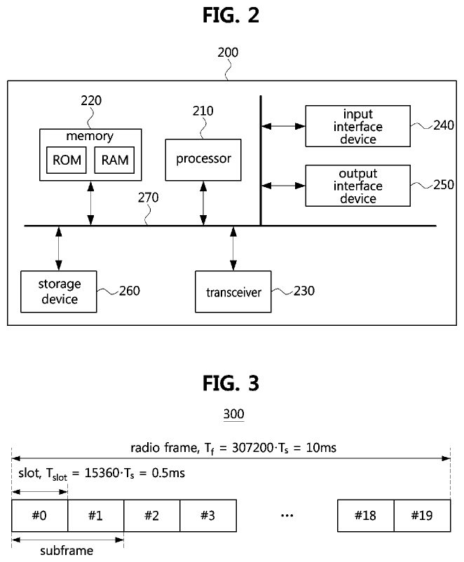

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, the communication system may support three types of frame structures. A type 1 frame structure may be applied to a frequency division duplex (FDD) communication system, a type 2 frame structure may be applied to a time division duplex (TDD) communication system, and a type 3 frame structure may be applied to an unlicensed band based communication system (e.g., a licensed assisted access (LAA) communication system).

FIG. 3 is a conceptual diagram illustrating a first exemplary embodiment of a type 1 frame.

Referring to FIG. 3, a radio frame 300 may comprise 10 subframes, and a subframe may comprise 2 slots. Thus, the radio frame 300 may comprise 20 slots (e.g., slot #0, slot #1, slot #2, slot #3, . . . , slot #18, and slot #19). The length T_{f} of the radio frame 300 may be 10 milliseconds (ms). The length of the subframe may be 1 ms, and the length Tₛₗₒₜ of a slot may be 0.5 ms. Here, Tₛ may indicate a sampling time, and may be 1/30,720,000s.

The slot may be composed of a plurality of OFDM symbols in the time domain, and may be composed of a plurality of resource blocks (RBs) in the frequency domain. The RB may be composed of a plurality of subcarriers in the frequency domain. The number of OFDM symbols constituting the slot may vary depending on configuration of a cyclic prefix (CP). The CP may be classified into a normal CP and an extended CP. If the normal CP is used, the slot may be composed of 7 OFDM symbols, in which case the subframe may be composed of 14 OFDM symbols. If the extended CP is used, the slot may be composed of 6 OFDM symbols, in which case the subframe may be composed of 12 OFDM symbols.

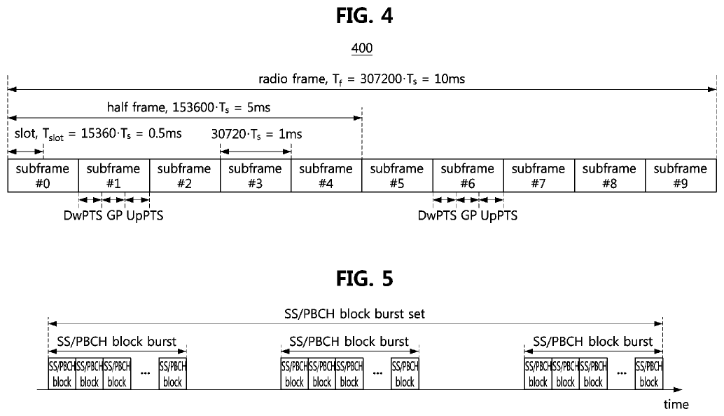

FIG. 4 is a conceptual diagram illustrating a first exemplary embodiment of a type 2 frame.

Referring to FIG. 4, a radio frame 400 may comprise two half frames, and a half frame may comprise 5 subframes. Thus, the radio frame 400 may comprise 10 subframes. The length T_{f} of the radio frame 400 may be 10 ms. The length of the half frame may be 5 ms. The length of the subframe may be 1 ms. Here, Tₛ may be 1/30,720,000s.

The radio frame 400 may include at least one downlink subframe, at least one uplink subframe, and a least one special subframe. Each of the downlink subframe and the uplink subframe may include two slots. The length Tₛₗₒₜ of a slot may be 0.5 ms. Among the subframes included in the radio frame 400, each of the subframe #1 and the subframe #6 may be a special subframe. For example, when a switching periodicity between downlink and uplink is 5 ms, the radio frame 400 may include 2 special subframes. Alternatively, the switching periodicity between downlink and uplink is 10 ms, the radio frame 400 may include one special subframe. The special subframe may include a downlink pilot time slot (DwPTS), a guard period (GP), and an uplink pilot time slot (UpPTS).

The downlink pilot time slot may be regarded as a downlink interval and may be used for cell search, time and frequency synchronization acquisition of the terminal, channel estimation, and the like. The guard period may be used for resolving interference problems of uplink data transmission caused by delay of downlink data reception. Also, the guard period may include a time required for switching from the downlink data reception operation to the uplink data transmission operation. The uplink pilot time slot may be used for uplink channel estimation, time and frequency synchronization acquisition, and the like. Transmission of a physical random access channel (PRACH) or a sounding reference signal (SRS) may be performed in the uplink pilot time slot.

The lengths of the downlink pilot time slot, the guard period, and the uplink pilot time slot included in the special subframe may be variably adjusted as needed. In addition, the number and position of each of the downlink subframe, the uplink subframe, and the special subframe included in the radio frame 400 may be changed as needed.

In the communication system, a transmission time interval (TTI) may be a basic time unit for transmitting coded data through a physical layer. A short TTI may be used to support low latency requirements in the communication system. The length of the short TTI may be less than 1 ms. The conventional TTI having a length of 1 ms may be referred to as a base TTI or a regular TTI. That is, the base TTI may be composed of one subframe. In order to support transmission on a base TTI basis, signals and channels may be configured on a subframe basis. For example, a cell-specific reference signal (CRS), a physical downlink control channel (PDCCH), a physical downlink shared channel (PDSCH), a physical uplink control channel (PUCCH), a physical uplink shared channel (PUSCH), and the like may exist in each subframe.

On the other hand, a synchronization signal (e.g., a primary synchronization signal (PSS) and a secondary synchronization signal (SSS)) may exist for every 5 subframes, and a physical broadcast channel (PBCH) may exist for every 10 subframes. Also, each radio frame may be identified by an SFN, and the SFN may be used for defining transmission of a signal (e.g., a paging signal, a reference signal for channel estimation, a signal for channel state information, etc.) longer than one radio frame. The periodicity of the SFN may be 1024.

In the LTE system, the PBCH may be a physical layer channel used for transmission of system information (e.g., master information block (MIB)). The PBCH may be transmitted every 10 subframes. That is, the transmission periodicity of the PBCH may be 10 ms, and the PBCH may be transmitted once in the radio frame. The same MIB may be transmitted during 4 consecutive radio frames, and after 4 consecutive radio frames, the MIB may be changed according to a situation of the LTE system. The transmission period for which the same MIB is transmitted may be referred to as a ‘PBCH TTI’, and the PBCH TTI may be 40 ms. That is, the MIB may be changed for each PBCH TTI.

The MIB may be composed of 40 bits. Among the 40 bits constituting the MIB, 3 bits may be used to indicate a system band, 3 bits may be used to indicate physical hybrid automatic repeat request (ARQ) indicator channel (PHICH) related information, 8 bits may be used to indicate an SFN, 10 bits may be configured as reserved bits, and 16 bits may be used for a cyclic redundancy check (CRC).

The SFN for identifying the radio frame may be composed of a total of 10 bits (B9 to B0), and the most significant bits (MSBs) 8 bits (B9 to B2) among the 10 bits may be indicated by the PBCH (i.e., MIB). The MSBs 8 bits (B9 to B2) of the SFN indicated by the PBCH (i.e., MIB) may be identical during 4 consecutive radio frames (i.e., PBCH TTI). The least significant bits (LSBs) 2 bits (B1 to B0) of the SFN may be changed during 4 consecutive radio frames (i.e., PBCH TTI), and may not be explicitly indicated by the PBCH (i.e., MIB). The LSBs (2 bits (B1 to B0)) of the SFN may be implicitly indicated by a scrambling sequence of the PBCH (hereinafter referred to as ‘PBCH scrambling sequence’).

A Gold sequence generated by being initialized by a cell ID may be used as the PBCH scrambling sequence, and the PBCH scrambling sequence may be initialized for each four consecutive radio frames (e.g., each PBCH TTI) based on an operation of ‘mod (SFN, 4)’. The PBCH transmitted in a radio frame corresponding to an SFN with LSBs 2 bits (B1 to B0) set to ‘00’ may be scrambled by the Gold sequence generated by being initialized by the cell ID. Thereafter, the Gold sequences generated according to the operation of ‘mod (SFN, 4)’ may be used to scramble the PBCH transmitted in the radio frames corresponding to SFNs with LSBs 2 bits (B1 to B0) set to ‘01’, ‘10’, and ‘11’.

Accordingly, the terminal having acquired the cell ID in the initial cell search process may identify the value of the LSBs 2 bits (B1 to B0) of the SFN (e.g., ‘00’, ‘01’, ‘10’, or ‘11’) based on the PBCH scramble sequence obtained in the decoding process for the PBCH (i.e., MIB). The terminal may use the LSBs 2 bits (B1 to B0) of the SFN obtained based on the PBCH scrambling sequence and the MSBs 8 bits (B9 to B2) of the SFN indicated by the PBCH (i.e., MIB) so as to identify the SFN (i.e., the entire bits B9 to B0 of the SFN).

The evolved mobile communication network after the LTE should satisfy technical requirements for supporting more diverse service scenarios as well as a high transmission rate, which has been a major concern in the prior arts. Recently, the ITU-R has defined key performance indicators (KPIs) and requirements for IMT-2020, the official name of 5G mobile communication, which are summarized as a high transmission rate (i.e., enhanced Mobile BroadBand (eMBB)), short transmission latency (i.e., Ultra-Reliable Low-Latency Communication (URLLC)), and massive terminal connectivity (i.e., massive Machine Type Communication (mMTC)). According to the ITU-R projected schedule, it aims to allocate frequencies for IMT-2020 in 2019 and complete international standard approvals by 2020.

The 3GPP is developing a new radio access technology (RAT)-based 5G standard that meets the IMT-2020 requirements. According to the definition of the 3GPP, the new RAT is a radio access technology that does not have backward compatibility with the existing 3GPP RAT. The new radio communication system after the LTE, which adopts such the RAT, will be referred to as new radio (NR) in the present disclosure.

One of characteristics of the NR different from the CDMA and LTE, which are the conventional 3GPP systems, is that it utilizes a wide range of frequency bands to increase transmission capacity. In this regard, the WRC-19 agenda hosted by the ITU was to review 24.25 to 86 GHz frequency bands as candidate frequency bands for IMT-2020. In the 3GPP, bands from a sub-1 GHz band to a 100 GHz band are considered as candidate NR bands.

As a waveform technology for the NR, Orthogonal Frequency Division Multiplexing (OFDM), Filtered OFDM, Generalized Frequency Division Multiplexing (GFDM), Filter Bank Multi-Carrier (FBMC), Universal Filtered Multi-Carrier (UFMIC), and/or the like are discussed as candidate technologies. Although each has pros and cons, Cyclic Prefix (CP)-based OFDM and Single Carrier-Frequency Division Multiple Access (SC-FDMA) are still effective schemes for the 5G system, due to their relatively low implementation complexity at a transceiver and Multiple-Input Multiple-Output (MIMO) scalability. However, in order to flexibly support various 5G usage scenarios, a method of simultaneously accommodating different waveform parameters within one carrier without guard bands may be considered, and for this case, the Filtered OFDM or GFDM having a low out-of-band Emission (OOB) may be suitable.

In the present disclosure, for convenience of description, it is assumed that the CP-based OFDM is used as a waveform technology for radio access. However, this is only for convenience of description, and various exemplary embodiments of the present disclosure are not limited to a specific waveform technology. In general, the category of CP-based OFDM technology includes the Filtered OFDM or Spread Spectrum OFDM (e.g., DFT-spread OFDM) technology.

The subcarrier spacing of the communication system (e.g., OFDM-based communication system) may be determined based on a carrier frequency offset (CFO) and the like. The CFO may be generated by a Doppler effect, a phase drift, or the like, and may increase in proportion to an operation frequency. Therefore, in order to prevent the performance degradation of the communication system due to the CFO, the subcarrier spacing may increase in proportion to the operation frequency. On the other hand, as the subcarrier spacing increases, a CP overhead may increase. Therefore, the subcarrier spacing may be configured based on a channel characteristic, a radio frequency (RF) characteristic, etc. according to a frequency band.

Various numerologies are being considered in the NR system. For example, the subcarrier spacing of the communication system may be configured to 15 kHz, 30 kHz, 60 kHz, or 120 kHz. The subcarrier spacing of the LTE system may be 15 kHz, and the subcarrier spacing of the NR system may be 1, 2, 4, or 8 times the conventional subcarrier spacing of 15 kHz. If the subcarrier spacing increases by exponentiation units of 2 of the conventional subcarrier spacing, the frame structure can be easily designed.

The communication system may support a wide frequency band (e.g., several hundred MHz to tens of GHz). Since the diffraction characteristic and the reflection characteristic of the radio wave are poor in a high frequency band, a propagation loss (e.g., path loss, reflection loss, and the like) in a high frequency band may be larger than a propagation loss in a low frequency band. Therefore, a cell coverage of a communication system supporting a high frequency band may be smaller than a cell coverage of a communication system supporting a low frequency band. In order to solve such the problem, a beamforming scheme based on a plurality of antenna elements may be used to increase the cell coverage in the communication system supporting a high frequency band.

The beamforming scheme may include a digital beamforming scheme, an analog beamforming scheme, a hybrid beamforming scheme, and the like. In the communication system using the digital beamforming scheme, a beamforming gain may be obtained using a plurality of RF paths based on a digital precoder or a codebook. In the communication system using the analog beamforming scheme, a beamforming gain may be obtained using analog RF devices (e.g., phase shifter, power amplifier (PA), variable gain amplifier (VGA), and the like) and an antenna array.

Because of the need for expensive digital to analog converters (DACs) or analog to digital converters (ADCs) for digital beamforming schemes and transceiver units corresponding to the number of antenna elements, the complexity of antenna implementation may be increased to increase the beamforming gain. In case of the communication system using the analog beamforming scheme, since a plurality of antenna elements are connected to one transceiver unit through phase shifters, the complexity of the antenna implementation may not increase greatly even if the beamforming gain is increased. However, the beamforming performance of the communication system using the analog beamforming scheme may be lower than the beamforming performance of the communication system using the digital beamforming scheme. Further, in the communication system using the analog beamforming scheme, since the phase shifter is adjusted in the time domain, frequency resources may not be efficiently used. Therefore, a hybrid beam forming scheme, which is a combination of the digital scheme and the analog scheme, may be used.

When the cell coverage is increased by the use of the beamforming scheme, common control channels and common signals (e.g., reference signal and synchronization signal) for all terminals belonging to the cell coverage as well as control channels and data channels for each terminal may also be transmitted based on the beamforming scheme. In the case of transmitting a common control channel or signal to all terminals while increasing the cell coverage by applying beamforming, it may be difficult to transmit the common control channel or signal to the entire cell coverage by single transmission, and the common control channel or signal should be transmitted several times over multiple beams. A scheme of transmitting a channel or signal several times through different beams over a period of time may be referred to as beam sweeping. When a common control channel or signal is transmitted by applying beamforming, such the beam sweeping operation is absolutely necessary.

A terminal desiring to access the system may acquire downlink frequency/time synchronization and cell ID information using a synchronization signal, acquire uplink synchronization through a random access procedure, and form a radio link. In this case, in the NR system, a synchronization signal/physical broadcast channel (SS/PBCH) block may also be transmitted in a beam sweeping scheme. The SS/PBCH block may be composed of a PSS, an SSS, a PBCH, and the like. In the SS/PBCH block, the PSS, the SSS, and the PBCH may be configured in a time division multiplexing (TDM) manner. The SS/PBCH block may be referred also to as an ‘SS block (SSB)’. One SS/PBCH block may be transmitted using N consecutive OFDM symbols. Here, N may be an integer equal to or greater than 4. The base station may periodically transmit the SS/PBCH block, and the terminal may acquire frequency/time synchronization, a cell ID, system information, and the like based on the SS/PBCH block received from the base station. The SS/PBCH block may be transmitted as follows.

FIG. 5 is a conceptual diagram illustrating a first exemplary embodiment of a transmission method of SS/PBCH block in a communication system.

Referring to FIG. 5, one or more SS/PBCH blocks may be transmitted in a beam sweeping scheme within an SS/PBCH block burst set. Up to L SS/PBCH blocks may be transmitted within one SS/PBCH block burst set. L may be an integer equal to or greater than 2, and may be defined in the 3GPP standard. Depending on a region of a system frequency, L may vary. Within the SS/PBCH block burst set, the SS/PBCH blocks may be located consecutively or distributedly. The consecutive SS/PBCH blocks may be referred to as an ‘SS/PBCH block burst’. The SS/PBCH block burst set may be repeated periodically, and system information (e.g., MIB) transmitted through the PBCHs of the SS/PBCH blocks within the SS/PBCH block burst set may be the same. An index of the SS/PBCH block, an index of the SS/PBCH block burst, an index of an OFDM symbol, an index of a slot, and the like may be indicated explicitly or implicitly by the PBCH.

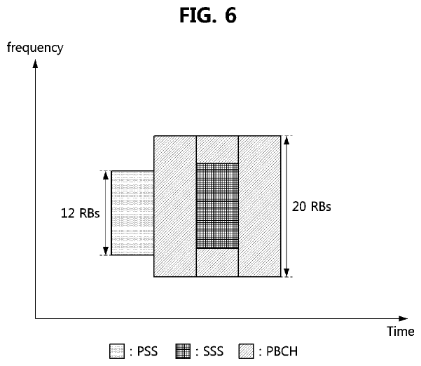

FIG. 6 is a conceptual diagram illustrating a first exemplary embodiment of an SS/PBCH block in a communication system.

Referring to FIG. 6, signals and a channel are arranged within one SS/PBCH block in the order of ‘PSS→PBCH→SSS→PBCH’. The PSS, SSS, and PBCH within the SS/PBCH block may be configured in a TDM scheme. In a symbol where the SSS is located, the PBCH may be located in frequency resources above the SSS and frequency resources below the SSS. That is, the PBCH may be transmitted in both end bands adjacent to the frequency band in which the SSS is transmitted. When the maximum number of SS/PBCH blocks is 8 in the sub 6 GHz frequency band, an SS/PBCH block index may be identified based on a demodulation reference signal used for demodulating the PBCH (hereinafter, referred to as ‘PBCH DMRS’). When the maximum number of SSBs is 64 in the over 6 GHz frequency band, LSB 3 bits of 6 bits representing the SS/PBCH block index may be identified based on the PBCH DMRS, and the remaining MSB 3 bits may be identified based on a payload of the PBCH.

The maximum system bandwidth that can be supported in the NR system may be 400 MHz. The size of the maximum bandwidth that can be supported by the terminal may vary depending on the capability of the terminal. Therefore, the terminal may perform an initial access procedure (e.g., initial connection procedure) by using some of the system bandwidth of the NR system supporting a wide band. In order to support access procedures of terminals supporting various sizes of bandwidths, SS/PBCH blocks may be multiplexed in the frequency domain within the system bandwidth of the NR system supporting a wide band. In this case, the SS/PBCH blocks may be transmitted as follows.

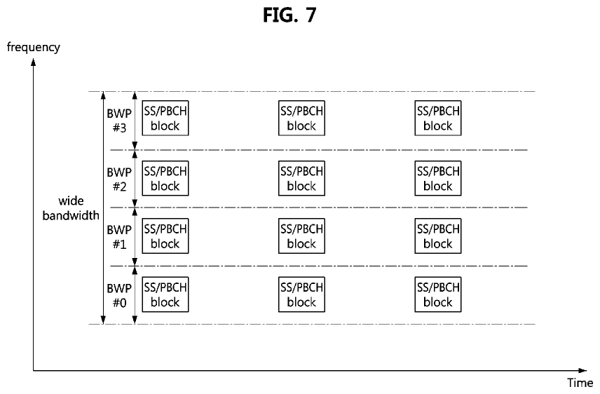

FIG. 7 is a conceptual diagram illustrating a second exemplary embodiment of a method of transmitting SS/PBCH blocks in a communication system.

Referring to FIG. 7, a wideband component carrier (CC) may include a plurality of bandwidth parts (BWPs). For example, the wideband CC may include 4 BWPs. The base station may transmit SS/PBCH blocks in the respective BWPs #0 to #3 belonging to the wideband CC. The terminal may receive the SS/PBCH block(s) from one or more BWPs of the BWPs #0 to #3, and may perform an initial access procedure using the received SS/PBCH block.

After detecting the SS/PBCH block, the terminal may acquire system information (e.g., remaining minimum system information (RMSI)), and may perform a cell access procedure based on the system information. The RMSI may be transmitted on a PDSCH scheduled by a PDCCH. Configuration information of a control resource set (CORESET) in which the PDCCH including scheduling information of the PDSCH through which the RMSI is transmitted may be transmitted on a PBCH within the SS/PBCH block. A plurality of SS/PBCH blocks may be transmitted in the entire system band, and one or more SS/PBCH blocks among the plurality of SS/PBCH blocks may be SS/PBCH block(s) associated with the RMSI. The remaining SS/PBCH blocks may not be associated with the RMSI. The SS/PBCH block associated with the RMSI may be defined as a ‘cell defining SS/PBCH block’. The terminal may perform a cell search procedure and an initial access procedure by using the cell-defining SS/PBCH block. The SS/PBCH block not associated with the RMSI may be used for a synchronization procedure and/or a measurement procedure in the corresponding BWP. The BWP(s) through which the SS/PBCH block is transmitted may be limited to one or more BWPs within a wide bandwidth.

The RMSI may be obtained by performing an operation to obtain configuration information of a CORESET from the SS/PBCH block (e.g., PBCH), an operation of detecting a PDCCH based on the configuration information of the CORESET, an operation to obtain scheduling information of a PDSCH from the PDCCH, and an operation to receive the RMSI through the PDSCH. A transmission resource of the PDCCH may be configured by the configuration information of the CORESET. A mapping patter of the RMSI CORESET pattern may be defined as follows. The RMSI CORESET may be a CORESET used for transmission and reception of the RMSI.

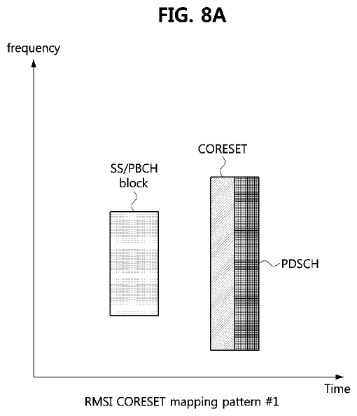

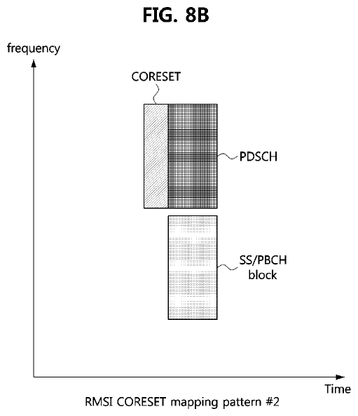

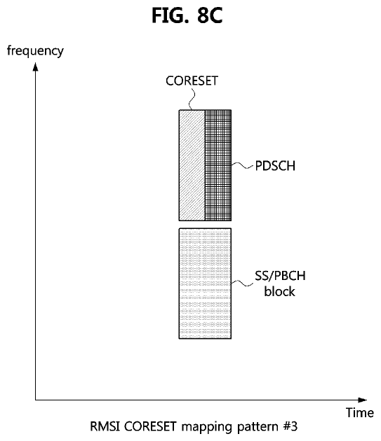

FIG. 8A is a conceptual diagram illustrating an RMSI CORESET mapping pattern #1 in a communication system, FIG. 8B is a conceptual diagram illustrating an RMSI CORESET mapping pattern #2 in a communication system, and FIG. 8C is a conceptual diagram illustrating an RMSI CORESET mapping pattern #3 in a communication system.

Referring to FIGS. 8A to 8C, one RMSI CORESET mapping pattern among the RMSI CORESET mapping patterns #1 to #3 may be used, and a detailed configuration according to the one RMSI CORESET mapping pattern may be determined. In the RMSI CORESET mapping pattern #1, the SS/PBCH block, the CORESET (i.e., RMSI CORESET), and the PDSCH (i.e., RMSI PDSCH) may be configured in a TDM scheme. The RMSI PDSCH may mean the PDSCH through which the RMSI is transmitted. In the RMSI CORESET mapping pattern #2, the CORESET (i.e., RMSI CORESET) and the PDSCH (i.e., RMSI PDSCH) may be configured in a TDM scheme, and the PDSCH (i.e., RMSI PDSCH) and the SS/PBCH block may be configured in a frequency division multiplexing (FDM) scheme. In the RMSI CORESET mapping pattern #3, the CORESET (i.e., RMSI CORESET) and the PDSCH (i.e., RMSI PDSCH) may be configured in a TDM scheme, and the CORESET (i.e., RMSI CORESET) and the PDSCH (i.e., RMSI PDSCH) may be multiplexed with the SS/PBCH block in a FDM scheme.

In the frequency band of 6 GHz or below, only the RMSI CORESET mapping pattern #1 may be used. In the frequency band of 6 GHz or above, all of the RMSI CORESET mapping patterns #1, #2, and #3 may be used. The numerology of the SS/PBCH block may be different from that of the RMSI CORESET and the RMSI PDSCH. Here, the numerology may be a subcarrier spacing. In the RMSI CORESET mapping pattern #1, a combination of all numerologies may be used. In the RMSI CORESET mapping pattern #2, a combination of numerologies (120 kHz, 60 kHz) or (240 kHz, 120 kHz) may be used for the SS/PBCH block and the RMSI CORESET/PDSCH. In the RMSI CORESET mapping pattern #3, a combination of numerologies (120 kHz, 120 kHz) may be used for the SS/PBCH block and the RMSI CORESET/PDSCH.

One RMSI CORESET mapping pattern may be selected from the RMSI CORESET mapping patterns #1 to #3 according to the combination of the numerology of the SS/PBCH block and the numerology of the RMSI CORESET/PDSCH. The configuration information of the RMSI CORESET may include Table A and Table B. Table A may represent the number of resource blocks (RBs) of the RMSI CORESET, the number of symbols of the RMSI CORESET, and an offset between an RB (e.g., starting RB or ending RB) of the SS/PBCH block and an RB (e.g., starting RB or ending RB) of the RMSI CORESET. Table B may represent the number of search space sets per slot, an offset of the RMSI CORESET, and an OFDM symbol index in each of the RMSI CORESET mapping patterns. Table B may represent information for configuring a monitoring occasion of the RMSI PDCCH. Each of Table A and Table B may be composed of a plurality of sub-tables. For example, Table A may include sub-tables 13-1 to 13-8 defined in the technical specification (TS) 38.213, and Table B may include sub-tables 13-9 to 13-13 defined in the TS 38.213. The size of each of Table A and Table B may be 4 bits.

In the case of the pattern #1 among three patterns for RMSI CORESET configurations shown in FIGS. 8A to 8C, the terminal may monitor a Type 0 CSS in two consecutive slots, and a position n₀ of a start slot for the Type 0 CSS monitoring may be calculated by Equation 1 below.

n₀=(O·2^{μ}+└i·M┘)mod Nₛₗₒₜ^{frame,μ} [Equation 1]

In Equation 1, μ is a parameter indicating a subcarrier spacing. A subcarrier spacing of 15 kHz is indicated by μ=0, a subcarrier spacing of 30 kHz is indicated by μ=1, a subcarrier spacing of 60 kHz is indicated by μ=2, and a subcarrier spacing of 120 kHz is indicated by μ=3. i indicates an SSB index of an SSB that the terminal receives from the base station (or, SSB that the base station transmits to the terminal), and in the case of operations in an unlicensed band, an SSB candidate index i of the SSB that the terminal receives from the base station (or, SSB that the base station transmits to the terminal) may be used instead of the SSB index i. Nₛₗₒₜ^{frame,μ} represents the number of slots having a subcarrier spacing corresponding to μ within a radio frame, and O and M are parameters configurable for scheduling flexibility of the base station. Specifically, when calculating a position of Type 0 CSS slots, O may indicate an offset between the SSB and the Type 0 CSS slot, and M may determine whether Type 0 CSS monitoring slots overlap or not when performing monitoring in two consecutive slots. M may be set to one of ½, 1, and 2, and a degree of overlapping between Type 0 CSS monitoring slots corresponding to SSB indexes may be configured differently according to M.

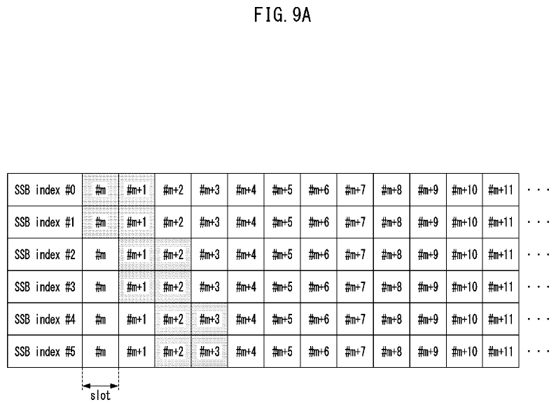

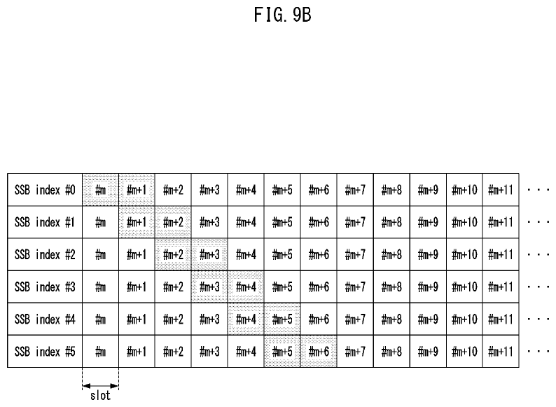

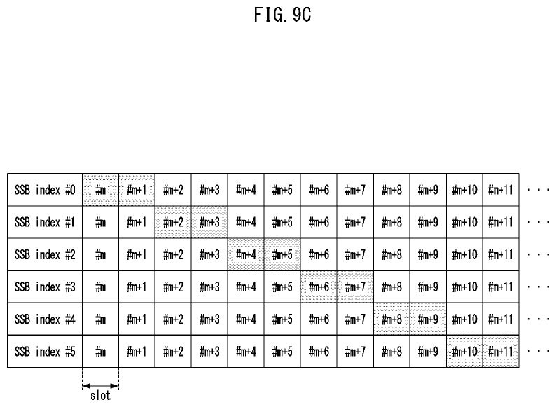

FIGS. 9A to 9C are diagrams for describing examples of various configurations of Type 0 CSS slots corresponding to SSB indexes.

Referring to FIG. 9A, in the case of M=½, Type 0 CSS slots (e.g., slot #m and slot #m+1) corresponding to two SSB indexes (e.g., SSB index #0 and SSB index #1) may be configured to be completely overlapped. Type 0 CSS slots (e.g., slot #m+1 and slot #m+2) corresponding to the next two SSB indexes (e.g., SSB index #2 and SSB index #3) may overlap only in one slot with the previous slots.

Referring to FIG. 9B, in the case of M=1, the first slot among two consecutive slots corresponding to each SSB index may be configured to overlap the second slot among two slots corresponding to a previous SSB index.

Referring to FIG. 9C, in the case of M=2, two consecutive slots corresponding to each SSB index may be configured not to overlap slots corresponding to other SSB indexes.

In the NR system, a PDSCH may be mapped to the time domain according to a PDSCH mapping type A or a PDSCH mapping type B. The PDSCH mapping types A and B may be defined as Table 2 below.

TABLE 1

| PDSCH | | | | | | |
|---|---|---|---|---|---|---|
| mapping | Normal CP | | | Extended CP | | |
| type | S | L | S + L | S | L | S + L |
| Type A | {0, 1, 2, 3} | {3, . . . , 14} | {3, . . . , 14} | {0, 1, 2, 3} | {3, . . . , 12} | {3, . . . , 12} |
| | (Note 1) | | | (Note 1) | | |
| Type B | {0, . . . , 12} | {2, 4, 7} | {2, . . . , 14} | {0, . . . , 10} | {2, 4, 6} | {2, . . . , 12} |

Note 1:
S = 3 is applicable only if dmrs-TypeA-Position = 3

The type A (i.e., PDSCH mapping type A) may be slot-based transmission. When the type A is used, a position of a start symbol of a PDSCH may be configured to one of {0, 1, 2, 31}. When the type A and a normal CP are used, the number of symbols constituting the PDSCH (e.g., the duration of the PDSCH) may be configured to one of 3 to 14 within a range not exceeding a slot boundary. The type B (i.e., PDSCH mapping type B) may be non-slot-based transmission. When the type B is used, a position of a start symbol of a PDSCH may be configured to one of 0 to 12. When the type B and the normal CP are used, the number of symbols constituting the PDSCH (e.g., the duration of the PDSCH) may be configured to one of { 2, 4, 7} within a range not exceeding a slot boundary. A DMRS (hereinafter, referred to as ‘PDSCH DMRS’) for demodulation of the PDSCH (e.g., data) may be determined by a value of ID indicating the PDSCH mapping type (e.g., type A or type B) and the length. The ID may be defined differently according to the PDSCH mapping type.

As NR phase 1 standardization is completed in release-15 and NR phase 2 standardization begins in release-16, new features of the NR system are being discussed. One of the representative features is NR-Unlicensed (U). The NR-U is a technology to support operations in an unlicensed spectrum used for purposes such as Wi-Fi to increase network capacity by increasing utilization of limited frequency resources. For such the operations in an unlicensed spectrum, standardization started with the LTE-Licensed-Assisted Access (LAA) technology from Release-13, and has continued to evolve through release-14 LTE-Enhanced LAA (eLAA) and release-15 LTE-Further Enhanced LAA (FeLAA). In the NR, standardization work is in progress as a work item (WI) in release-16 after a study item (SI) for the NR-U.

In the NR-U system, the terminal may determine whether a signal is transmitted from a base station based on a discovery reference signal (DRS) received from the corresponding base station in the same manner as in the general NR system. In the NR-U system in a Stand-Alone (SA) mode, the terminal may acquire synchronization and/or system information based on the DRS. In the NR-U system, the DRS may be transmitted according to a regulation of the unlicensed band (e.g., transmission band, transmission power, transmission time, etc.). For example, according to Occupied Channel Bandwidth (OCB) regulations, signals may be configured and/or transmitted to occupy 80% of the total channel bandwidth (e.g., 20 MHz).

In the NR-U system, a communication node (e.g., base station, terminal) may perform a Listen Before Talk (LBT) procedure before transmitting a signal and/or a channel for coexistence with another system. The signal may be a synchronization signal, a reference signal (e.g., DRS, DMRS, channel state information (CSI)-RS, phase tracking (PT)-RS, sounding reference signal (SRS)), or the like. The channel may be a downlink channel, an uplink channel, a sidelink channel, or the like. In exemplary embodiments, a signal may mean the ‘signal’, the ‘channel’, or the ‘signal and channel’. The LBT procedure may be an operation for checking whether a signal is transmitted by another communication node. If it is determined by the LBT procedure that there is no transmission signal (e.g., when the LBT procedure is successful), the communication node may transmit a signal in the unlicensed band. If it is determined by the LBT procedure that a transmission signal exists (e.g., when the LBT fails), the communication node may not be able to transmit a signal in the unlicensed band. The communication node may perform a LBT procedure according to one of various categories before transmission of a signal. The category of LBT may vary depending on the type of the transmission signal.

Another one of the representative features in release-16 phase 2 is NR-Vehicular-to-Everything (V2X). The V2X is a technology that supports communications in various scenarios such as vehicle-to-vehicle, vehicle and infrastructure, vehicle and pedestrian based on LTE Device to Device (D2D) communication. A lot of discussion for the V2X communication has been made in the LTE system, and it continues to develop even now. In the NR, with the start of release-16, discussion on the NR V2X has been started.

The NR V2X communication (e.g., sidelink communication) may be performed according to three transmission schemes (e.g., unicast scheme, broadcast scheme, groupcast scheme). When the unicast scheme is used, a PC5-RRC connection may be established between a first terminal (e.g. transmitting terminal that transmits data) and a second terminal (e.g., receiving terminal that receives data), and the PC5-RRC connection may refer to a logical connection for a pair between a source ID of the first terminal and a destination ID of the second terminal. The first terminal may transmit data (e.g., sidelink data) to the second terminal. When the broadcast scheme is used, the first terminal may transmit data to all terminals. When the groupcast scheme is used, the first terminal may transmit data to a group (e.g., groupcast group) composed of a plurality of terminals.

When the unicast scheme is used, the second terminal may transmit feedback information (e.g., acknowledgment (ACK) or negative ACK (NACK)) to the first terminal in response to data received from the first terminal. In the exemplary embodiments below, the feedback information may be referred to as a ‘HARQ-ACK’, ‘feedback signal’, a ‘physical sidelink feedback channel (PSFCH) signal’, or the like. When ACK is received from the second terminal, the first terminal may determine that the data has been successfully received at the second terminal. When NACK is received from the second terminal, the first terminal may determine that the second terminal has failed to receive the data. In this case, the first terminal may transmit additional information to the second terminal based on an HARQ scheme. Alternatively, the first terminal may improve a reception probability of the data at the second terminal by retransmitting the same data to the second terminal.

When the broadcast scheme is used, a procedure for transmitting feedback information for data may not be performed. For example, system information may be transmitted in the broadcast scheme, and the terminal may not transmit feedback information for the system information to the base station. Therefore, the base station may not identify whether the system information has been successfully received at the terminal. To solve this problem, the base station may periodically broadcast the system information.

When the groupcast scheme is used, a procedure for transmitting feedback information for data may not be performed. For example, necessary information may be periodically transmitted in the groupcast scheme, without the procedure for transmitting feedback information. However, when the candidates of terminals participating in the groupcast scheme-based communication and/or the number of the terminals participating in that is limited, and the data transmitted in the groupcast scheme is data that should be received within a preconfigured time (e.g., data sensitive to delay), it may be necessary to transmit feedback information also in the groupcast sidelink communication. The groupcast sidelink communication may mean sidelink communication performed in the groupcast scheme. When the feedback information transmission procedure is performed in the groupcast sidelink communication, data can be transmitted and received efficiently and reliably.

In the groupcast sidelink communication, two HARQ-ACK feedback schemes (i.e., transmission procedures of feedback information) may be supported. When the number of receiving terminals in a sidelink group is large and a service scenario 1 is supported, some receiving terminals belonging to a specific range within the sidelink group may transmit NACK through a PSFCH when data reception fails. This scheme may be a groupcast HARQ-ACK feedback option 1. In the service scenario 1, instead of all the receiving terminals in the sidelink group, it may be allowed for some receiving terminals belonging to a specific range to perform reception in a best-effort manner. The service scenario 1 may be an extended sensor scenario in which some receiving terminals belonging to a specific range need to receive the same sensor information from a transmitting terminal. In exemplary embodiments, the transmitting terminal may refer to a terminal transmitting data, and the receiving terminal may refer to a terminal receiving data.

When the number of receiving terminals in the sidelink group is limited and a service scenario 2 is supported, each of all the receiving terminals belonging to the sidelink group may report HARQ-ACK for data individually through a separate PSFCH. This scheme may be a groupcast HARQ-ACK feedback option 2. In the service scenario 2, since PSFCH resources are sufficient, the transmitting terminal may perform monitoring on HARQ-ACK feedbacks of all the receiving terminals belonging to the sidelink group, and data reception may be guaranteed at all the receiving terminals belonging to the sidelink group. Whether or not the ACK/NACK feedback procedure is applied to each of all the transmission schemes may be statically or semi-statically configured through system information and UE-specific RRC signaling, and dynamic configuration thereof may also be possible through control information.

In addition, data reliability at the receiving terminal may be improved by appropriately adjusting a transmit power of the transmitting terminal according to a transmission environment. Interference to other terminals may be mitigated by appropriately adjusting the transmit power of the transmitting terminal. Energy efficiency can be improved by reducing unnecessary transmit power. A power control scheme may be classified into an open-loop power control scheme and a closed-loop power control scheme. In the open-loop power control scheme, the transmitting terminal may determine the transmit power in consideration of configuration, a measured environment, etc. In the closed-loop power control scheme, the transmitting terminal may determine the transmit power based on a transmit power control (TPC) command received from the receiving terminal.

It may be difficult due to various causes including a multipath fading channel, interference, and the like to predict a received signal strength at the receiving terminal. Accordingly, the receiving terminal may adjust a receive power level (e.g., receive power range) by performing an automatic gain control (AGC) operation to prevent a quantization error of the received signal and maintain a proper receive power. In the communication system, the terminal may perform the AGC operation using a reference signal received from the base station. However, in the sidelink communication (e.g., V2X communication), the reference signal may not be transmitted from the base station. That is, in the sidelink communication, communication between terminals may be performed without the base station. Therefore, it may be difficult to perform the AGC operation in the sidelink communication. In the sidelink communication, the transmitting terminal may first transmit a signal (e.g., reference signal) to the receiving terminal before transmitting data, and the receiving terminal may adjust a receive power range (e.g., receive power level) by performing an AGC operation based on the signal received from the transmitting terminal. Thereafter, the transmitting terminal may transmit sidelink data to the receiving terminal. The signal used for the AGC operation may be a signal duplicated from a signal to be transmitted later or a signal preconfigured between the terminals.

A time period required for the ACG operation may be 15 μs. When a subcarrier spacing of 15 kHz is used in the NR system, a time period (e.g., length) of one symbol (e.g., OFDM symbol) may be 66.7 μs. When a subcarrier spacing of 30 kHz is used in the NR system, a time period of one symbol (e.g., OFDM symbol) may be 33.3 μs. In the following exemplary embodiments, a symbol may mean an OFDM symbol. That is, a time period of one symbol may be twice or more than a time period required for the ACG operation.

For sidelink communication, it may be necessary to transmit a data channel for data transmission and a control channel including scheduling information for data resource allocation. In sidelink communication, the data channel may be a physical sidelink shared channel (PSSCH), and the control channel may be a physical sidelink control channel (PSCCH). The data channel and the control channel may be multiplexed in a resource domain (e.g., time and frequency resource domains).

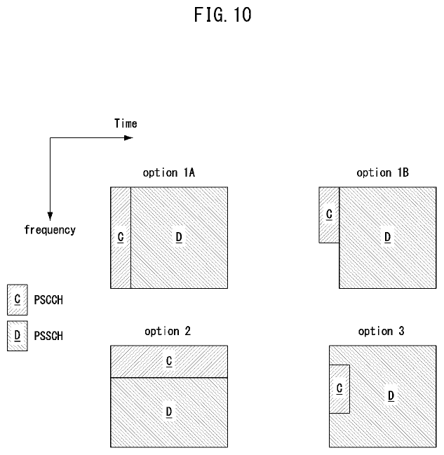

FIG. 10 is a conceptual diagram illustrating exemplary embodiments of a method for multiplexing a control channel and a data channel in sidelink communication.

Referring to FIG. 10, sidelink communication may support an option 1A, an option 1B, an option 2, and an option 3. When the option 1A and/or the option 1B is supported, a control channel and a data channel may be multiplexed in the time domain When the option 2 is supported, a control channel and a data channel may be multiplexed in the frequency domain. When the option 3 is supported, a control channel and a data channel may be multiplexed in the time and frequency domains. The sidelink communication may basically support the option 3.

In the sidelink communication (e.g., NR-V2X sidelink communication), a basic unit of resource configuration may be a subchannel. The subchannel may be defined with time and frequency resources. For example, the subchannel may be composed of a plurality of symbols (e.g., OFDM symbols) in the time domain, and may be composed of a plurality of resource blocks (RBs) in the frequency domain. The subchannel may be referred to as an RB set. In the subchannel, a data channel and a control channel may be multiplexed based on the option 3.

In the sidelink communication (e.g., NR-V2X sidelink communication), transmission resources may be allocated based on a mode 1 or a mode 2. When the mode 1 is used, a base station may allocate sidelink resource(s) for data transmission within a resource pool to a transmitting terminal, and the transmitting terminal may transmit data to a receiving terminal using the sidelink resource(s) allocated by the base station. Here, the transmitting terminal may be a terminal that transmits data in sidelink communication, and the receiving terminal may be a terminal that receives the data in sidelink communication.

When the mode 2 is used, a transmitting terminal may autonomously select sidelink resource(s) to be used for data transmission by performing a resource sensing operation and/or a resource selection operation within a resource pool. The base station may configure the resource pool for the mode 1 and the resource pool for the mode 2 to the terminal(s). The resource pool for the mode 1 may be configured independently from the resource pool for the mode 2. Alternatively, a common resource pool may be configured for the mode 1 and the mode 2.

When the mode 1 is used, the base station may schedule a resource used for sidelink data transmission to the transmitting terminal, and the transmitting terminal may transmit sidelink data to the receiving terminal by using the resource scheduled by the base station. Therefore, a resource conflict between terminals may be prevented. When the mode 2 is used, the transmitting terminal may select an arbitrary resource by performing a resource sensing operation and/or resource selection operation, and may transmit sidelink data by using the selected arbitrary resource. Since the above-described procedure is performed based on an individual resource sensing operation and/or resource selection operation of each transmitting terminal, a conflict between selected resources may occur.

The sidelink communication system supporting Release-16 may be designed for terminals (e.g., vehicle-mounted terminals, vehicle UEs (V-UEs)) that do not have restrictions on battery capacity. Therefore, a power saving issue may not be greatly considered in resource sensing/selection operations for such the terminals. However, in order to perform sidelink communication with terminals having restrictions on battery capacity in the sidelink communication system supporting Release-17 (e.g., a terminal carried by a pedestrian, a terminal mounted on a bicycle, a terminal mounted on a motorcycle, a pedestrian UE (P-UE)), power saving methods will be required. In the present disclosure, a ‘V-UE’ may refer to a terminal that has no significant restrictions on battery capacity, a ‘P-UE’ may refer to a terminal with restrictions on battery capacity, and a ‘resource sensing/selection operation’ may refer to a resource sensing operation and/or a resource selection operation. The resource sensing operation may refer to a partial sensing operation or a full sensing operation. The resource selection operation may refer to a random selection operation. In addition, in the present disclosure, an ‘operation of a terminal’ may be interpreted as an ‘operation of a V-UE’ and/or ‘operation of a P-UE’.

For power saving in the LTE V2X, a partial sensing operation and/or a random selection operation has been introduced. When the partial sensing operation is supported, the terminal may perform resource sensing operations in partial periods instead of an entire period within a sensing window, and may select a resource based on a result of the partial sensing operation. According to such the operation, power consumption of the terminal may be reduced. When the random selection operation is supported, the terminal may randomly select a resource without performing the resource sensing operation. Alternatively, the random selection operation may be performed together with the resource sensing operation. For example, the terminal may determine resources by performing the resource sensing operation, and may select a resource(s) by performing the random selection operation within the determined resources.

In the LTE V2X supporting Release-14, a resource pool in which the partial sensing operation and/or random selection operation can be performed may be configured independently of a resource pool in which the full sensing operation can be performed. A resource pool capable of performing the random selection operation, a resource pool capable of performing the partial sensing operation, and a resource pool capable of performing the full sensing operation may be independently configured. The terminal may select resources by performing the random selection operation, the partial sensing operation, and/or the full sensing operation in the resource pool(s). The terminal may select one operation among the random selection operation and the partial sensing operation, may select a resource(s) by performing the selected sensing operation, and may perform sidelink communication by using the selected resource(s).

In the LTE V2X supporting Release-14, sidelink (SL) data may be periodically transmitted based on a broadcast scheme. In the NR communication system, SL data may be transmitted based on a broadcast scheme, multicast scheme, groupcast scheme, or unicast scheme. In addition, in the NR communication system, SL data may be transmitted periodically or aperiodically. A transmitting terminal may transmit SL data to a receiving terminal, and the receiving terminal may transmit a HARQ feedback (e.g., acknowledgement (ACK) or negative ACK (NACK)) for the SL data to the transmitting terminal on a PSFCH. In the present disclosure, a transmitting terminal may refer to a terminal transmitting SL data, and a receiving terminal may refer to a terminal receiving the SL data.

Hereinafter, methods for enhancing transmission and monitoring/reception of control channels in a communication system will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

A terminal having reduced capability (hereinafter, referred to as a ‘RedCap terminal’) may operate in a specific usage environment. The capability of the RedCap terminal may be lower than the capability of a new radio (NR) normal (i.e., legacy) terminal, and may be higher than that of an LTE-machine type communication (LTE-MTC) terminal, a narrow band internet of things (NB-IoT) terminal, or a low power wide area (LPWA) terminal. For example, a terminal (e.g., surveillance cameras) that requires ‘high data rate and non-high latency condition’ and/or a terminal (e.g., wearable device) that requires ‘non-high data rate, high latency condition, and high reliability’ may exist. In order to support the above-described terminals, the maximum carrier bandwidth in FR1 may be reduced from 100 MHz to 20 MHz, and the maximum carrier bandwidth in FR2 may be reduced from 400 MHz to 100 MHz. The number of reception antennas of the RedCap terminal may be smaller than the number of reception antennas of the NR normal terminal. When the carrier bandwidth and the number of reception antennas are reduced, a reception performance of the RedCap terminal may decrease, and accordingly, the coverage of the RedCap terminal may decrease. In the NR system, search space sets for PDCCH monitoring may be configured in the terminal.

Search space sets may be classified into a common search space (CSS) commonly configured for a plurality of terminals and a UE-specific search space (USS) specifically configured for a terminal. Various types of CSSs may exist according to types of a PDCCH that can be received in the corresponding search space set, and PDCCH monitoring occasions may be configured differently according to each CSS and USS. For example, in the case of a Type 1 CSS (with dedicated RRC configuration), Type 3 CSS, and USS, PDCCH monitoring occasion(s) may be configured only in the first three OFDM symbol(s) within a slot. In addition, in the case of a PDCCH monitoring case 1 (or group 1) SS, Type 1 CSS (without dedicated RRC configuration), Type 0 CSS, Type OA CSS, and Type 2 CSS, PDCCH monitoring occasion(s) may be configured in any three consecutive OFDM symbols within a slot. In addition, a PDCCH monitoring case 2 (or group 2) SS, Type 0 CSS for receiving a PDCCH for SIB1 reception, Type 0A CSS for receiving a PDCCH for reception of other system information (OSI) other than a SIB1, Type 1 CSS for receiving a PDCCH related to a random access procedure, Type 2 CSS for receiving a paging message, and Type 3 CSS are CSSs for receiving various group-common PDCCHs. Similarly to a USS, a PDCCH including scheduling information for an individual terminal may be received in some of these CSSs. In the NR system, in order to reduce the complexity and power consumption of the terminal, the number of PDCCH candidates that the terminal can attempt to detect PDCCHs in a PDCCH monitoring process may be limited by the PDCCH blind decoding capability and the channel estimation capability of the terminal. The capability of the terminal may be defined by the number of monitorable PDCCH candidates and the number of monitorable non-overlapped control channel elements (CCEs). In the NR release-15, the terminal's PDCCH blind decoding capability and channel estimation capability are defined as shown in the tables below.

Table 2 defines the maximum number M_{PDCCH}^{max,slot,μ} of monitorable PDDCH candidates per slot for a downlink BWP having a subcarrier spacing (SCS) configuration μ (μ∈{0,1,2,3}) for a single serving cell.

TABLE 2

| | Maximum number of monitored PDCCH candidates |
|---|---|
| μ | per slot and per serving cell M_{PDCCH}^{max, slot, μ} |
| 0 | 44 |
| 1 | 36 |
| 2 | 22 |
| 3 | 20 |

Table 3 defines the maximum number C_{PDCCH}^{max,slot,μ} of non-overlapped CCEs per slot for a downlink BWP with a SCS configuration μ (μ∈{0,1,2,3}) for a single serving cell.

TABLE 3

| | Maximum number of non-overlapped CCEs |
|---|---|
| μ | per slot and per serving cell C_{PDCCH}^{max, slot, μ} |
| 0 | 56 |
| 1 | 56 |
| 2 | 48 |
| 3 | 32 |

Tables 2 and 3 show the maximum number of monitorable PDCCH candidates and the maximum number of monitorable non-overlapped CCEs according to each SCS (15 kHz for μ=0, 30 kHz for μ=1, 60 kHz for μ=2, and 120 kHz for μ=3), respectively. The per-slot upper limits according to a SCS may be configured for the number of PDCCH candidates and the number of non-overlapped CCEs that can be monitored within a downlink BWP. When the number of PDCCH candidates and/or the number of non-overlapped CCEs configured in the corresponding slot exceeds the upper limit(s), monitoring of some PDCCH candidates may not be performed according to a predetermined order.

For configuration of frequent PDCCH monitoring occasions for low-latency transmission, new ‘span-based PDCCH blind decoding capability and channel estimation capability’ have been introduced in the NR release-16. A span means consecutive symbols within a slot, which are configured for PDCCH monitoring of the terminal. The terminal may report span combinations each having a form of (X, Y) to report the span-based PDCCH monitoring capability. The terminal may report supportable one or more combinations among three span combinations of (2, 2), (4, 3), and (7, 3) for 15 kHz SCS and 30 kHz SCS, respectively. The PDCCH monitoring capability of the terminal according to each span combination may be defined as the maximum number of PDCCH candidates that can be monitored within one span and the maximum number of non-overlapped CCEs that can be monitored within one span. The PDCCH monitoring capability for each SCS and each span combination may be defined as shown in the tables below.

Table 4 defines the maximum number M_{PDCCH}^{max,(X,Y),μ} of monitorable PDDCH candidates for each span combination (X, Y) for a downlink BWP having a SCS configuration μ(μ∈{0,1}) for a single serving cell.

TABLE 4

| | Maximum number M_{PDCCH}^{max, (X, Y), μ} monitored PDCCH | | |
|---|---|---|---|
| | candidates per span for combination (X, Y) and per serving cell | | |
| μ | (2, 2) | (4, 3) | (7, 3) |
| 0 | 14 | 28 | 44 |
| 1 | 12 | 24 | 36 |

Table 5 defines the maximum number C_{PDCCH}^{max,(X,Y),μ} of non-overlapped CCEs for each span combination (X, Y) for a downlink BWP having a SCS configuration μ(μ∈{0,1}) for a single serving cell.

TABLE 5

| | Maximum number C_{PDCCH}^{max, (X, Y), μ} of non-overlapped | | |
|---|---|---|---|
| | CCEs per span for combination (X, Y) and per serving cell | | |
| μ | (2, 2) | (4, 3) | (7, 3) |
| 0 | 18 | 36 | 56 |
| 1 | 18 | 36 | 56 |

In the span combination (X, Y), X means the minimum time interval between first symbols of two adjacent spans, and Y means the maximum length of symbols in each span (i.e., the number of symbols in each span).

FIG. 11 is a conceptual diagram for describing a span combination (X=4, Y=3) for PDCCH monitoring.

Referring to FIG. 11, the terminal may be configured to perform PDCCH monitoring in a total of 9 symbols within one slot. Since the first symbols of spans are spaced apart by an interval of 4 symbols or more, and the length of each span does not exceed three symbols, the condition of the span combination (4, 3) may be satisfied.

In the NR release-17, a discussion has begun to support operations of the NR system in a frequency band of 52.6 GHz or above (e.g., 52.6 GHz to 71 GHz (i.e., FR2-2 band)) by extending the existing 24.25 GHz to 52.6 GHz frequency band (i.e., FR2-1 band). As the frequency band increases, support of larger subcarrier spacings for more robust operations to frequency offset errors and phase noises has been discussed. In addition to 60 kHz and 120 kHz subcarrier spacings used in the existing FR2 band, 480 kHz and 960 kHz subcarrier spacings may be applied for initial access and data transmission/reception, and designs of physical layer signals and channels, and physical layer procedures are also being discussed in accordance with the support of larger subcarrier spacings. For the initial access procedure, unlike 120 kHz and 240 kHz SSBs supported in the existing FR2-1 band, 480 kHz and 960 kHz SSBs have been introduced in addition to the 120 kHz SSBs in the FR2-2 band. In data transmission/reception, additional support for 480 kHz and 960 kHz subcarrier spacings have been determined, and discussion on improvement of control channel monitoring and transmission methods is ongoing. As the subcarrier spacing increases, the OFDM symbol length and the slot length may decrease in inverse proportion. When the 480 kHz and 960 kHz subcarrier spacings are used, the slot length is reduced to ¼ and ⅛, respectively, compared to the 120 kHz subcarrier spacing used for data transmission in the existing FR2-1 band. Accordingly, when the terminal, which has been monitoring PDCCHs for every slot, also monitors PDCCHs for every slot in a slot configured with the larger subcarrier spacing, the complexity and power consumption of the terminal may greatly increase. Therefore, the present disclosure proposes methods for improving PDCCH transmission and monitoring according to the introduction of the new subcarrier spacings.

As described above, when the new subcarrier spacing is applied, the length of the slot is reduced to ¼ or ⅛ compared to the existing shortest slot length, so it may be difficult to perform PDCCH monitoring for every slot. Accordingly, an exemplary embodiment of the present disclosure proposes a method of reducing overhead due to PDCCH monitoring by configuring a specific slot span to perform PDCCH monitoring only in some slot(s) within the corresponding slot span. Here, the specific slot span is composed of X slots, and PDCCH monitoring is enabled only in the maximum Y slots (i.e., PDCCH monitoring slots) among the X slots, thereby preventing increasement of complexity and power consumption of the terminal when the terminal performs PDCCH monitoring for every slot. In this case, a plurality of slot span combinations, each of which is defined by (X, Y), may be preconfigured in the terminal, and the terminal may report, for each SCS, one or more supportable slot span combinations among them. Here, X may indicate the length of a slot span, and Y may indicate the number of PDCCH monitoring slot(s) within one slot span. The base station may properly configure PDCCH monitoring occasions for the terminal in consideration of the one or more supportable slot span combinations reported by the terminal. A plurality of X values may be configured in consideration of a subcarrier spacing and various service scenarios in the configuration of the slot span combinations, and Y may be appropriately set within the X value in consideration of the terminal capability. More specifically, Y may be preferably set as 1≤Y≤X/2. However, even if Y is set within the above range, the effect of reducing the complexity of the terminal may be degraded according to the actual positions of the Y slots (i.e., PDCCH monitoring slots).

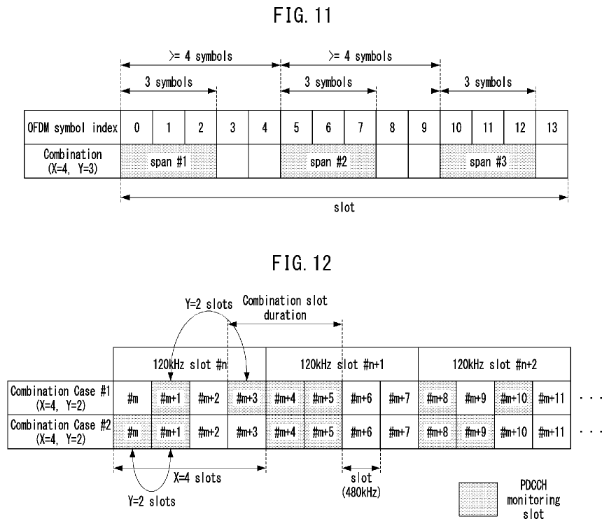

FIG. 12 is a conceptual diagram illustrating an example of configuring PDCCH monitoring slots according to a slot span combination (X=4, Y=2) for PDCCH monitoring.

Referring to FIG. 12, both of Case #1 and Case #2 exemplify cases in which two (i.e., Y=2) PDCCH monitoring slots are configured within a slot span composed of four (i.e., X=4) slots. Case #1 is a case in which the PDCCH monitoring slots (i.e., Y slots) can be freely located within the corresponding slot span, and Case #2 is a case in which the PDCCH monitoring slots (i.e., Y slots) can be located only in a starting part of the corresponding slot span.

The both cases satisfy the condition of (X=4, Y=2). However, since a case (e.g., expressed as ‘congested slot duration’ in FIG. 12) in which PDCCH monitoring slots are consecutively located between consecutive slot spans may occur in Case #1, it may be difficult to obtain the effect of reducing the complexity and power consumption of the terminal. Accordingly, an exemplary embodiment of the present disclosure proposes a method in which the positions of the PDCCH monitoring slots always start from the starting part of the corresponding slot span. When the PDCCH monitoring slots (i.e., Y slots) start from the beginning of the corresponding slot span composed of X slots, a case in which the PDCCH monitoring slots are configured consecutively between consecutive slot spans as in Case #1 of FIG. 12 may be prevented. However, when the PDCCH monitoring slots are configured to start from the beginning of the corresponding slot span as in Case #2 of FIG. 12, scheduling flexibility may be reduced. In Case #2, since two slots (i.e., Y slots) at the beginning of the corresponding slot span are always configured as PDCCH monitoring slots, it may be prevented that PDCCH monitoring slots are configured consecutively between consecutive slot spans. However, since PDCCHs for scheduling should be always located only in Y slots at the beginning of the slot span, scheduling restrictions may occur accordingly. Accordingly, an exemplary embodiment of the present disclosure proposes a method capable of preventing the configuration of PDCCH monitoring slots consecutive between consecutive slot spans and increasing scheduling flexibility at the same time. Specifically, although the PDCCH monitoring slots (i.e., Y slots) are located from the beginning of the corresponding slot span, a method of configuring a maximum allowable offset Z between the PDCCH monitoring slots may be used. For example, in case of a slot span combination (X=4, Y=2, Z=1), a maximum of two (i.e., Y=2) PDCCH monitoring slots may be configured from a starting part of a slot span consisting of four (i.e., X=4) slots, and in this case, an offset of at most one slot (Z=1) may be applied between the PDCCH monitoring slots. In this case, since an offset of at most one slot (Z=1) may be applied between the PDCCH monitoring slots, 0 or 1 may be applied as the slot offset between the PDCCH monitoring slots.

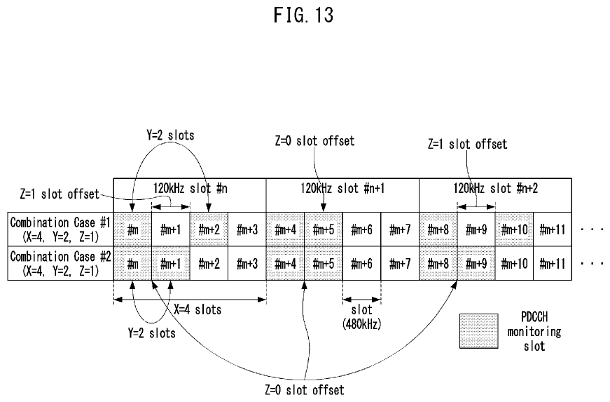

FIG. 13 is a conceptual diagram illustrating an example of configuring PDCCH monitoring slots according to a slot span combination (X=4, Y=2, Z=1) for PDCCH monitoring.

Referring to FIG. 13, Case #1 is a case in which slot offsets {1, 0, 1} are sequentially applied to slot spans, respectively, and Case #2 is a case in which only a slot offset=0 is applied to all slot spans. By additionally configuring the maximum allowable slot offset between the PDCCH monitoring slots within the slot span in this manner, the PDCCH monitoring slots may be prevented from being consecutively configured between consecutive slot spans, and the PDCCH monitoring slots may be prevented from being located always in fixed positions, whereby scheduling flexibility can be improved. In the slot span combination (X, Y, Z), Y may be set as 1≤Y≤X/2 in consideration of X set for each subcarrier spacing, and Z may be preferably set to an appropriate value preventing the PDCCH monitoring slots from being configured consecutively between consecutive slot spans, in consideration of X and Y.

In the above example, the method in which Z is set as the maximum allowable slot offset between the Y PDCCH monitoring slots within the corresponding slot span is proposed. However, as another method, a minimum allowable offset between PDCCH monitoring slots configured in consecutive slot spans may be configured. For example, when consecutive slot spans X1 and X2 exist, the minimum offset between the last PDCCH monitoring slot(s) in the slot span X1 and the first PDCCH monitoring slot(s) in the slot span X2 should be Z slot(s) or more.

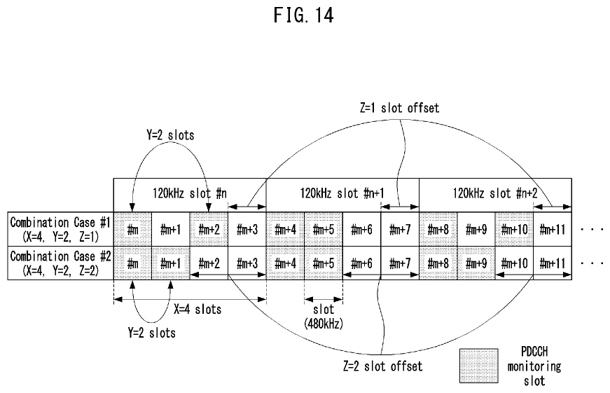

FIG. 14 is a conceptual diagram illustrating another example of configuring PDCCH monitoring slots according to a slot span combination (X=4, Y=2, Z=1) for PDCCH monitoring.

Referring to FIG. 14, Case #1 is a case in which a minimum allowable slot offset Z is set to 1. An interval between the last PDCCH monitoring slot(s) of the first slot span among two consecutive slot spans and the first PDCCH monitoring slot(s) of the second slot span among the two consecutive slot spans may be configured to be at least one slot. More specifically, one slot may be configured as the interval between the last PDCCH monitoring slot (i.e., slot #m+2) of the first slot span and the first PDCCH monitoring slot (i.e., slot #m+4) of the second slot span, and two slots (≥1 slot) may be configured as the interval between the last PDDCH monitoring slot (i.e., slot #m+5) of the second slot span and the first PDCCH monitoring slot (i.e., slot #m+8) of the third slot span. Case #2 is a case in which a minimum allowable slot offset Z is set to 2. An interval between the last PDDCH monitoring slot of the first slot span among two consecutive slot spans and the first PDCCH monitoring slot of the second slot span among them may be configured to be at least two slots. In the slot span combination (X, Y, Z), Y may be set as 1≤Y≤X/2 in consideration of X set for each subcarrier spacing, and Z may be preferably set to an appropriate value preventing the PDCCH monitoring slots from being configured consecutively between consecutive slot spans and allowing Y PDCCH monitoring slots to be disposed within the corresponding slot span, in consideration of X and Y.

In another method, position(s) of PDCCH monitoring slot(s) may be configured only by the slot span combination (X, Y) without the parameter Z indicating an offset applied between PDCCH monitoring slots within one slot span or between PDCCH monitoring slots of consecutive slot spans. In this case, a start position of the PDCCH monitoring slot(s) may be freely located within the slot span, unlike Case #2 of FIG. 14, but the PDCCH monitoring slot(s) may be configured consecutively from the corresponding start position. The above-described configuration may provide a flexibility of PDCCH monitoring position configuration to the base station while reducing the complexity of the terminal. In this case, according to two groups (i.e., group 1 SS and group 2 SS) divided according to the type and characteristics of the SS, the PDDCH monitoring slots may be configured separately into two groups (i.e.,) Y_{Group1}, Y_{Group2}) That is, slot(s) belonging to Y_{Group1} (hereinafter, Y_{Group1} slot(s)) may be slot(s) in which a group 1 SS can be configured, and slot(s) belonging to Y_{Group2} (hereinafter, Y_{Group2} slot(s)) may be slot(s) in which a group 2 SS can be configured. In the existing NR system, since the group 2 SS is used in the initial access procedure, etc., and the position of slot(s) used in the initial access procedure is configured by a predetermined equation according to an SSB index of an SSB received by the terminal, it may be preferable that Y_{Group2} slot(s) in which the group 2 SS can be configured are also configured by a predetermined equation determined according to the SSB index. In order to reduce the complexity of the terminal, it may be preferable that the positions of the Y_{Group1} slot(s) in which the group 1 SS can be configured are configured to overlap in time with the positions of the Y_{Group2} slot(s). Therefore, it may be preferable that Y is determined by Y=max(Y_{Group1}, 2) (i.e., when Y_{Group1}≥Y_{Group2}) or Y=max(Y_{Group2}, 2) (i.e., when Y_{Group1}≤Y_{Group2}), not Y=Y_{Group1}±Y_{Group2}. When determining the positions of Y_{Group1} slot(s) and the Y_{Group2} slot(s), it may be preferable to configure the positions of the Y_{Group1} slot(s) by applying a predetermined offset to the positions of Y_{Group2} slot(s). The predetermined offset may be 0. Alternatively, one or a plurality of values among a plurality of preset values may be configured as the predetermined offset through system information or a UE-specific RRC parameter, or one or more predefined values may be used as the predetermined offset. When a plurality of offset values are configured, a specific offset value among the plurality of offset values may be applied according to the position of Y_{Group2} slot(s) within the slot span.

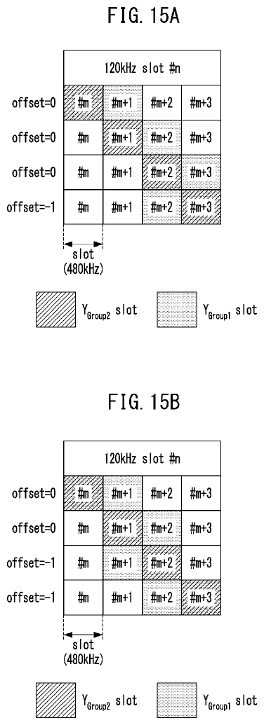

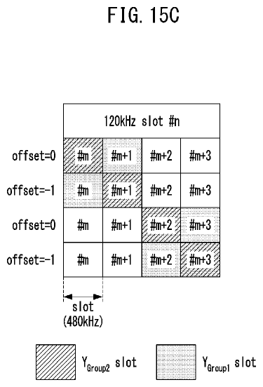

FIGS. 15A to 15C are diagrams for describing examples of configuring a position of Y_{Group1} slot(s) by applying an offset to a position of Y_{Group2} slot(s).

As described above, the position of Y_{Group2} slot(s) may be configured by a predetermined equation according to an SSB index or an SSB candidate index of the SSB that the terminal receives from the base station (or, the SSB that the base station transmits to the terminal). The position of Y_{Group1} slot(s) may be determined by applying a plurality of offset values ({0, −1}) to the position determined by the predetermined equation according to the SSB index or the SSB candidate index. In this case, the applied offset value may be determined according to the position of Y_{Group2} slot(s) within the slot span. FIGS. 15A to 15C illustrate examples in which different offset values are applied according to the positions of Y_{Group2} slot(s). These offset values may be applied differently for each terminal or may be equally applied to all terminals.

As described above, when the position of Y_{Group2} slot(s) is determined according to the SSB index or SSB candidate index, a Type 0 CSS may be configured in the corresponding slot(s). Also, in case of monitoring a Type 0 CSS by configuring a slot span combination, at least two Y_{Group2} slots for the Type 0 CSS should be configured. In this case, two consecutive slots may be configured in various manners in consideration of scheduling flexibility of the base station.

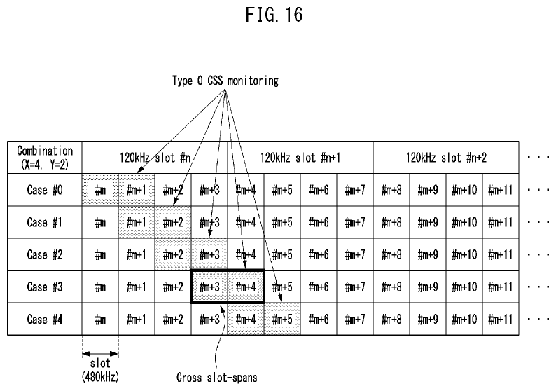

FIG. 16 is a conceptual diagram illustrating a first exemplary embodiment of configuring Y_{Group2} slots for Type 0 CSS.

Referring to FIG. 16, a start position n₀ of Y_{Group2} slot(s) may be determined by an SSB index or SSB candidate index, and the Y_{Group2} slots may be configured in two consecutive slots n₀ and n₀+1. Meanwhile, in Case #3, since two Y_{Group2} slots are configured over different slot spans, the maximum number of PDCCH candidates that can be monitored within a slot span (hereinafter, the maximum number of BDs) and the maximum number of non-overlapped CCEs that can be monitored within a slot span (hereinafter, the maximum number of CCEs) may be difficult to manage. As a method to solve this, the limits of the maximum number of BDs and the maximum number of CCEs within a slot span may not be applied to the group 2 SS. That is, the limits of the maximum number of BDs and the maximum number of CCEs within a slot span may be applied only to the group 1 SS. In this case, if the maximum number of BDs and the maximum number of CCEs for the group 1 SS and/or group 2 SS exceeds the maximum allowable value for the terminal, monitoring for the group 1 SS may be preferentially abandoned. As another method, by configuring an additional span based on the position of the group 2 SS, the maximum number of BDs and the maximum number of CCEs may be limited within the additionally configured span. However, such the method may complicate the monitoring procedure for the group 1 SS and group 2 SS.

Accordingly, in an exemplary embodiment of the present disclosure, the position of Y_{Group2} slot(s) may be configured to a slot (i.e., slot n₀) of a start position and a slot (i.e., n₀+X) to which an offset of X slots is applied rather than two consecutive slots n₀ and n₀+1 from the start position configured according to the SSB index or SSB candidate index.

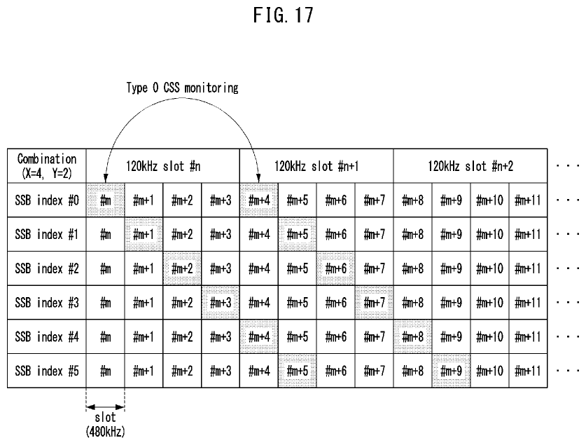

FIG. 17 is a conceptual diagram illustrating a second exemplary embodiment of configuring Y_{Group2} slots for Type 0 CSS.

Referring to FIG. 17, the problem in which Y_{Group2} slots are configured over different slot spans as in FIG. 16 may be solved. However, when various M values defined for scheduling flexibility of the base station are applied, scheduling flexibility may not be provided unlike the existing method.

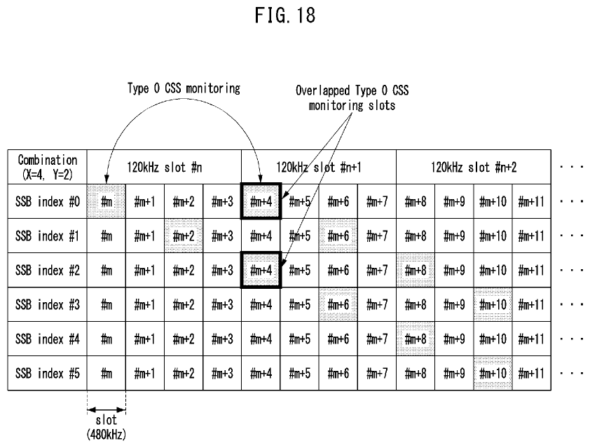

FIG. 18 is a conceptual diagram illustrating a third exemplary embodiment of configuring Y_{Group2} slots for Type 0 CSS.

Referring to FIG. 18, in case that Type 0 CSS slots corresponding to the SSB index or SSB candidate index are configured as slots n₀ and n₀+X when M=2, the Type 0 CSS slots configured to correspond to an SSB index #0 and an SSB index #2 may be configured to overlap in some slots.

Since the main function of M=2 is to configure Type 0 CSS slots corresponding to the respective SSB indexes so that they do not overlap each other, the case configured as shown in FIG. 18 may be a case that the main function is not properly reflected. Therefore, it may be preferable not to use the corresponding configuration. That is, only M=½ or M=1 may be supported without support for the case of M=2. The case of M=2 may be used for configuration of parameter(s) other than the parameter M or may be configured to be reserved for future configuration. Alternatively, Type 0 CSS slots may be configured using a different value instead of M=2. More specifically, when a value which is a prime number with respect to X is applied, Type 0 CSS slots corresponding to SSB indexes may be configured so that they do not overlap each other.

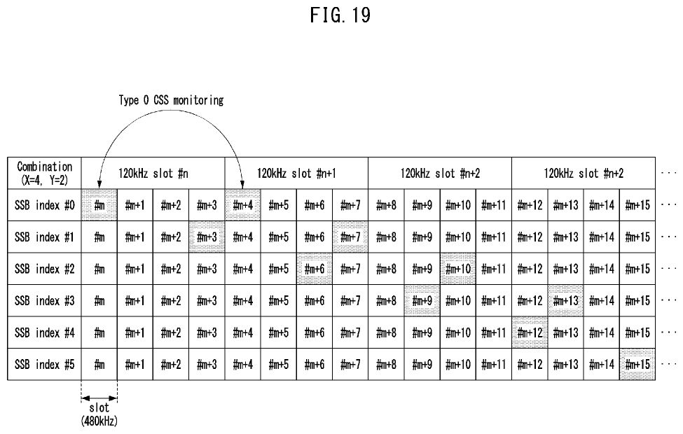

FIG. 19 is a conceptual diagram illustrating a fourth exemplary embodiment of configuring Y_{Group2} slots for Type 0 CSS.

Referring to FIG. 19, when M=3 is applied, Type 0 CSS slots corresponding to the respective SSB indexes may be configured so as not to overlap each other. However, it may be preferable to be able to apply various M values as before in consideration of scheduling flexibility of the base station and the existing operations of the terminal. Accordingly, in an exemplary embodiment of the present disclosure, an equation for calculating n₀ is proposed as follows so that Type 0 CSS slots do not overlap each other while maintaining the configuration of M=2.

n₀=(O·2^{μ}+└i·M┘·X)mod Nₛₗₒₜ^{frame,μ} [Equation 2]

In Equation 2, μ is a parameter indicating a subcarrier spacing. The subcarrier spacing of 480 kHz is indicated by μ=5, and the subcarrier spacing of 960 kHz is indicated by μ=6. X indicates the number of slots constituting a slot span combination. The remaining parameters are the same as the corresponding parameters of Equation 1. When the value of n₀, which is a start position of Type 0 CSS slots corresponding to an SSB index, is calculated by Equation 2, the problem of overlapping Type 0 CSS slots when the configuration of M=2 is applied as in FIG. 18 may be solved.

However, since the above methods require a change in the existing operations of the terminal that monitors two consecutive slots, the complexity of the terminal may increase accordingly. Therefore, in an exemplary embodiment of the present disclosure, the method of monitoring two consecutive slots configured from the start position determined according to the SSB index or SSB candidate index is maintained as it is, but a method of applying an offset of X slots to determination of the start position of Y_{Group2} slots according to the SSB index or SSB candidate index may be used. For example, in the existing method, the start position of Y_{Group2} slot(s) determined according to the SSB index or SSB candidate index may be configured to increase by 1 slot as the SSB index or SSB candidate index increases by ‘1’ as shown in FIG. 16, but in a proposed method, the start position of Y_{Group2} slot(s) may be configured to increase by X slots as the SSB index or SSB candidate index increases by ‘1’. This may be expressed by substituting i·X instead of SSB index i in the existing equation for calculating n₀, which is the start position of Y_{Group2} slot(s).

n₀=(O·2^{μ}+└i·X·M┘)mod Nₛₗₒₜ^{frame,μ} [Equation 3]

In Equation 3, the parameters are the same as the corresponding parameters in Equation 2. Type 0 CSS slots corresponding to the SSB index or SSB candidate index may be configured as slots n₀ and n₀+1 as in the existing case instead of slots n₀ and n₀+X.

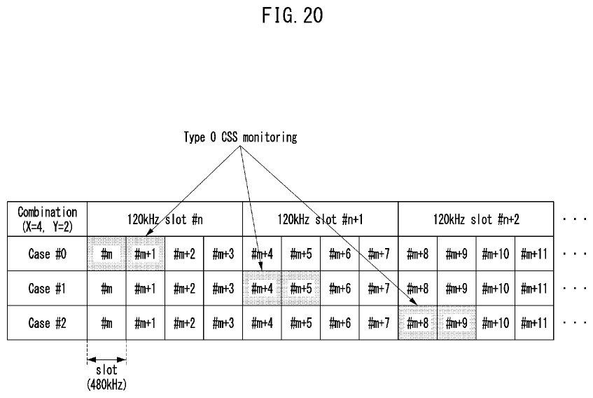

FIG. 20 is a conceptual diagram illustrating a fifth exemplary embodiment of configuring Y_{Group2} slots for Type 0 CSS.

Referring to FIG. 20, after calculating the start position of Y_{Group2} slot(s) using Equation 3 in which i·X is substituted for the SSB index i in the existing equation for calculating n₀, two consecutive slots from the start position may be configured as Y_{Group2} slots. By configuring Y_{Group2} slot(s) in this manner, as shown in FIG. 16, the problem in which Y_{Group2} slot(s) are configured over different slot spans may be solved, and at the same time, the operation of the terminal that monitors the Type 0 CSS in two consecutive slots may be maintained as it is.

Meanwhile, the above examples were described based on the SSB index i, but the exemplary embodiments of the present disclosure may be applied by substituting an SSB candidate index i instead of the SSB index i for operations in an unlicensed band.

In the existing NR system, it was possible to perform PDCCH monitoring for every slot up to the 120 kHz subcarrier spacing. Therefore, in the case of 480 kHz and 960 kHz subcarrier spacings, considering that 4 and 8 slots may be included within a slot according to the 120 KHz subcarrier spacing, respectively, it may be preferable that X is set to 4 in the case of 480 kHz subcarrier spacing and X is set to 8 in the case of 960 kHz subcarrier spacing to ensure the same PDCCH monitoring occasions as in a slot according to the 120 kHz subcarrier spacing. On the other hand, it may be basically preferable to support the configuration of X=1 regardless of a subcarrier spacing so that PDCCH monitoring is possible for every slot. In this case, Y should be set to 1 and Z should be set to 0 (if the parameter Z exists). In addition, it is possible to set X having a value other than the above values.

In the above exemplary embodiments, a specific slot span may be generally configured for all slots regardless of DL/UL configuration. However, since a slot span is for configuring PDCCH monitoring occasion(s), slot(s) belonging to the slot span may be limited to slot(s) having DL symbols more than or equal to a specific threshold. The corresponding threshold may be predefined or configured through system information or UE-specific RRC signaling. Alternatively, a slot span may be limited to slot(s) having DL symbols and/or flexible symbols equal to or more than a specific threshold.

When a slot span combination is configured based on all slot(s) regardless of DL/UL configuration, a case where slot(s) configured as PDCCH monitoring occasion(s) is configured as UL slot(s) or a case where the number of DL symbols or flexible symbols for PDCCH monitoring is not sufficient in the slot(s) configured as PDCCH monitoring occasion(s) may occur. In this case, the PDCCH monitoring occasion(s) may be configured by selecting any other DL slot(s) or selecting other slot(s) having a sufficient number of DL symbols or flexible symbols within the corresponding slot span combination. As another method, configuration of the PDCCH monitoring occasion(s) may be omitted in the corresponding slot(s) according to the slot span combination.

In the TDD UL/DL configuration of the NR system, up to two UL/DL patterns may be configured. Each pattern may be configured with a periodicity of a TDD UL/DL pattern, the number x1 of DL full slots consisting only of DL symbols at a start position of each pattern, the number x2 of consecutive DL symbols from a starting part of the slot after the DL full slots, the number y1 of UL full slots consisting only of UL symbols from a last position of each pattern, and the number y2 of consecutive UL symbols from an ending part of the slot immediately before the UL full slots.

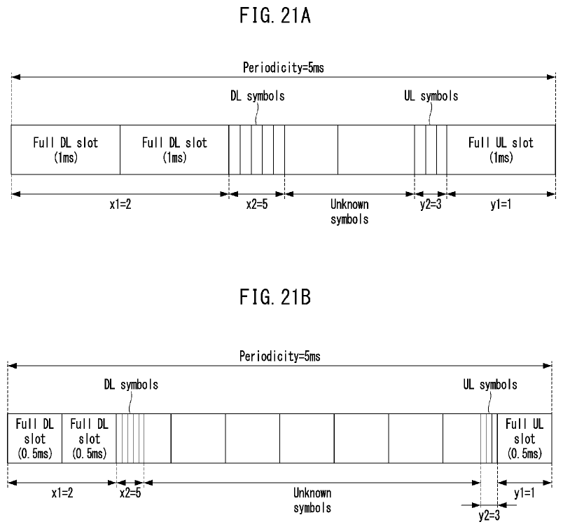

FIGS. 21A and 21B are conceptual diagrams for describing examples of TDD UL/DL configuration of the NR system.

Referring to FIGS. 21A and 21B, when a TDD UL/DL configuration periodicity is 5 ms, and configuration of x1=2, x2=5, y1=1, and y2=3 is used, configuration examples of TDD UL/DL patterns for the subcarrier spacings 15 KHz and 30 kHz are illustrated.

The TDD UL/DL configurations of FIGS. 21A and 21B may be commonly configured to all terminals through system information. In the configurations, unknown symbols may be additionally configured as UL or DL symbols through UE-specific signaling. When one TDD UL/DL configuration pattern is configured, the pattern is repeatedly configured within 20 ms with a periodicity P1 of the pattern, and when two TDD UL/DL configuration patterns (i.e., pattern1 and pattern2) are configured, the two patterns may be configured repeatedly within 20 ms with a periodicity of P1+P2 which is a sum of periodicities of the two patterns.

In the existing NR system, the TDD UL/DL pattern configuration was designed considering only up to the subcarrier spacing of 120 kHz, but as the subcarrier spacings of 480 kHz and 960 kHz are additionally introduced, a method for configuring a TDD UL/DL pattern in accordance therewith is required. Therefore, an exemplary embodiment of the present disclosure proposes a TDD UL/DL pattern configuration method in consideration of the additionally introduced subcarrier spacings. When a new pattern periodicity, etc. is introduced in consideration of the newly added subcarrier spacings, standardization works and system complexity may increase accordingly. Therefore, in an exemplary embodiment of the present disclosure, a method of configuring a TDD UL/DL pattern in consideration of a ratio between the existing 120 kHz subcarrier spacing and the newly introduced subcarrier spacing may be used. More specifically, the periodicity value among the existing configuration parameters may be used as it is, and the other parameters x1, x2, y1, and y2 also may be used as they are. However, when configuring an actual TDD UL/DL pattern, a method of using the parameters multiplied by a ratio between the newly-introduced subcarrier spacing and the existing 120 kHz subcarrier spacing may be used. For example, in the case of the 480 kHz subcarrier spacing, since it has four times the size of the 120 kHz subcarrier spacing (i.e., 480 kHz/120 kHz=4), x1*4, x2*4, y1*4 and y2*4 may be applied instead of the conventionally configured parameters x1, x2, y1 and y2. In the case of the 960 kHz subcarrier spacing, 8 (i.e., 960 kHz/120 kHz=8) may be applied instead of 4. As the subcarrier spacing increases, the number of slots included within one period also increases proportionally. Therefore, it is possible to configure a TDD UL/DL pattern without introducing additional parameters in the above-described manner. In this case, the parameter x1 and the parameter y1 may be directly converted into the number of slots multiplied by the ratio between subcarrier spacings. However, when the parameter x2 or the parameter y2 is multiplied by the ratio between subcarrier spacing, a case where the number of symbols exceeds the number of symbols per slot may occur. When the number of symbols obtained from the multiplication by the ratio between subcarrier spacings exceeds the number of symbols per slot, a slot fully occupied by DL (or UL) symbols may be considered a DL (or UL) full slot, and a slot partially occupied by DL (or UL) symbols may be defined as a DL (or UL) partial slot. For example, assuming the subcarrier spacing of 480 kHz and x2=5, the actual number of DL symbols, which is obtained by multiplication by the ratio between subcarrier spacings, may be 5*4=20. In this case, because 14 DL symbols can constitute one DL full slot, the number of DL full slots may be increased by 1 from x1*4, and only the remaining 6 DL symbols may be configured to be located in a starting part of the next slot. The same rule may be applied also to UL symbols. As another method, the number of partial slots including x2 (or y2) DL (or UL) symbols may be increased by the ratio between subcarrier spacings. For example, assuming the subcarrier spacing of 480 kHz and x2=5, four slots in which five DL symbols are configured at a starting part of each may be configured. The same rule may be applied also to UL symbols.

When configuring the PDCCH monitoring occasions according to the configured TDD UL/DL pattern, as described above, the slot span(s) may be configured only in consideration of slots having DL symbols or ‘DL symbols and flexible symbols’ more than or equal to a preset threshold. In this case, it may be preferable that the slot span(s) is configured with slots satisfying the above condition within a corresponding period in consideration of 20 ms which is the configuration periodicity of the TDD UL/DL pattern. When the number of slots satisfying the above condition within a 20 ms period is X_tot, the number of slot spans within the 20 ms period may be preferably set to ceil(X_tot/X). That is, the slot span(s) each consisting of X slots may be sequentially applied, and even when the last span has less than X slots, the last slot span may be configured to have less than X slots. When the number of slots in the last slot span is smaller than X, it may be difficult to configure the PDCCH monitoring occasion(s) in consideration of Y and Z, as in other slot spans. Therefore, it may be preferable for the last slot span that the PDCCH monitoring slot(s) are always consecutively configured from the start of the last slot span. In addition, when the number of slots in the last slot span is smaller than Y, it may be preferable that all slots (smaller than Y) are configured as PDCCH monitoring slot(s).

As described above, when the PDDCH monitoring slot(s) are configured in the slot span according to the slot span combination (X, Y, Z), PDCCH monitoring occasion(s) may be configured within the corresponding PDCCH monitoring slot(s) through search space (SS) configuration (SS configuration). The existing SS configuration indicates a SS start position within the slot by using a 14-bit bitmap. Unlike the case where PDCCH monitoring is possible for every slot, a search space configuration method is required in consideration of the case where the PDCCH monitoring occasion(s) is configured within the slot span as the subcarrier spacing increases. In an exemplary embodiment of the present disclosure, a method of repeatedly applying the conventional 14-bit bitmap signaling to the PDDCH monitoring slot(s) within the slot span as it is may be used. That is, signaling overhead may be reduced by applying the same SS configuration to a plurality of PDCCH monitoring slots with one 14-bit bitmap signaling. In this case, the PDCCH monitoring occasion(s) configured in the PDCCH monitoring slots within the slot span may need to be appropriately configured to have a complexity and power consumption similar to the complexity and power consumption for the existing subcarrier spacing (e.g., 120 kHz). For example, when the 14-bit bitmap according to the 120 kHz subcarrier spacing is set to {11110000000000}, the PDCCH monitoring occasion(s) may be started in four symbols within the slot. When the 480 kHz subcarrier spacing is used and a slot span combination (X=4, Y=2, Z=1) is configured, since PDCCH monitoring occasion(s) may be configured in two (=Y) slots for each slot span, the 14-bit bitmap may be repeatedly applied to the two slots. Therefore, in consideration of this, it may be preferable to configure PDCCH monitoring occasion(s) to start in two symbols within each slot by setting the 14-bit bitmap to {110000000000000}. As another method, the existing 14-bit bitmap may be used as it is, but each bit of the corresponding bitmap may indicate a symbol at an interval of Y symbols, unlike each bit of the existing bitmap indicating each symbol within the slot. That is, when the slot span combination (X=4, Y=2, Z=1) is configured, the 14-bit bitmap set to {11110000000000} may indicate that a start symbol of the PDCCH monitoring occasion (s) is configured in four symbols at an interval of two symbols among 28 symbols within two slots, not that the start symbol of the PDCCH monitoring occasion(s) is configured in the first four symbols among fourteen symbols within one slot.

As described above, when PDDCH monitoring slots composed of Y slots are configured within a slot span composed of X slots according to the slot span combination (X, Y), Y_{Group2} slot(s) among Y_{Group1} slot(s) and Y_{Group2} slot(s) may be configured based on the SSB index or SSB candidate index of the SSB that the terminal receives from the base station (or, the SSB that the base station transmits to the terminal), and the position of Y_{Group1} slot(s) may be configured by applying a specific offset value to the position of Y_{Group2} slot(s), so that the Y_{Group1} slot(s) and Y_{Group2} slot(s) are configured to overlap in the time domain. In this case, the group 1 SS may be configured within Y_{Group1} slot(s). In the existing NR system, an SS is configured using a slot-based monitoring periodicity and an offset of the SS (i.e., parameter monitoringPeriodicityAndOffset), a length of the SS (i.e., parameter duration), and bitmap information indicating a position of a SS monitoring start symbol within the slot (i.e., parameter monitoringSymbolsWithinSlot). In this case, the parameter duration indicates the length of the slot(s) to which the bitmap information is applied. Since the SS can be configured only within Y_{Group1} slot(s) within the slot span, it may be difficult to apply the existing SS configuration method. In addition, when the SSB index or SSB candidate index is changed due to the movement of the terminal, the change of Y_{Group2} slot(s) and the change of Y_{Group1} slot(s) may occur accordingly, so frequent RRC reconfigurations may occur, which may lead to an increase in system overhead, terminal operation complexity, delay time, and the like. Therefore, an exemplary embodiment of the present disclosure proposes an SS configuration method for solving this problem. The base station may configure an SS to the terminal by using the previously used parameter(s) as they are. However, unlike the existing method in which the terminal monitors PDCCHs in all SS monitoring occasion(s) configured by the base station, the terminal may perform PDCCH monitoring only in SS monitoring occasion(s) configured in Y_{Group1} slot(s) configured based in the SSB index or SSB candidate index (i.e., Y_{Group1} slot(s) configured based on the position of Y_{Group2} slot(s) configured based on the SSB index or SSB candidate index) among SS monitoring occasion(s) configured by the base station. More specifically, the parameter duration among the parameters for SS configuration may be set to include a plurality of slot spans, and PDCCH monitoring may be performed only in SS monitoring occasions included within Y_{Group1} slot(s) configured in association with Y_{Group2} slot(s) configured based on the SSB index or SSB candidate index within the duration (or within Y_{Group2} slot(s)). In the proposed method, the parameter duration may indicate the number of consecutive slot spans, unlike the existing duration indicating the number of consecutive slots. Also, in the proposed method, the bitmap may be applied only to Y_{Group1} slot(s) (or Y_{Group2} slot(s)) in the consecutive slot spans, not to all slots in the consecutive slot spans.

As another method, SS monitoring occasions may be configured based on the conventional parameters monitoringPeriodicityAndOffset and duration. In this case, a periodicity according to monitoringPeriodicityAndOffset may be preferably set to an integer multiple of X slots, and an offset according to monitoringPeriodicityAndOffset may also be preferably set in units of X slots, not on a slot basis. The parameter duration indicating the slot spans to which monitoringSymbolsWithinSlot, which is bitmap information indicating a position of an SS monitoring start symbol within a SS monitoring slot, is applied may also be set to an integer multiple of X slots. The monitoringSymbolsWithinSlot (i.e., second parameter), which is bitmap information indicating the position of the SS monitoring start symbol, may be equally applied to slots within the slot spans indicated by the parameter duration, and may be configured to applied to specific slot(s) within the slot spans by using an additional parameter (e.g., monitoringSlotsWithinSlotGroup, i.e., first parameter). That is, SS monitoring occasions may be finally configured by applying the bitmap information (i.e., monitoringSymbolsWithinSlot) indicating the position of the SS monitoring start symbol only to the slot(s) configured by the additional parameter (i.e., monitoringSlotsWithinSlotGroup). The additional parameter monitoringSlotsWithinSlotGroup may indicate PDCCH monitoring slots within the slot span in form of a bitmap. When the numbers of slots (X slots) included in the respective slot spans have various values, the size of the bitmap may be determined based on the maximum value among the various values. When a slot span is configured with slots less than the maximum value, bits corresponding to the number of slots may be sequentially applied from an MSB of the bitmap, and other bits may be ignored. As another method, when the slot(s) configured within the slot span are always consecutive, the signaling overhead may be reduced by signaling a position of a start slot and the number of consecutive slots from the start slot configured within the slot span, rather than by signaling the bitmap.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A control channel reception method performed by a terminal, comprising:
reporting, to a base station, information on at least one slot span combination supportable by the terminal for physical downlink control channel (PDCCH) monitoring;
identifying PDCCH occasion(s) for PDCCH(s) to be transmitted from the base station based on the at least one slot span combination supportable by the terminal; and
performing PDCCH monitoring in the identified PDCCH occasion(s).

2. The control channel reception method according to claim 1, wherein the information on at least one slot span combination supportable by the terminal for PDCCH monitoring is reported for each of subcarrier spacings supported by the terminal.

3. The control channel reception method according to claim 2, wherein when the terminal operates in a frequency band of 52.6 GHz or above, the sub-carrier spacings include 480 kHz and 960 kHz subcarrier spacings.

4. The control channel reception method according to claim 1, wherein each of the at least one slot span combination is indicated by (X, Y), X indicates a number of slot(s) constituting one slot span, and Y indicates a number of PDCCH monitoring slot(s) included in one slot span.

5. The control channel reception method according to claim 1, wherein each of the at least one slot span combination is indicated by (X, Y), X indicates a number of slot(s) constituting one slot span, and Y is determined based on a number of PDCCH monitoring slot(s) for a group 1 search space (SS) and/or a number of PDCCH monitoring slot(s) for a group 2 search space (SS), the group 1 SS and the group 2 SS being included in the one slot span.

6. The control channel reception method according to claim 5, wherein a position of the PDCCH monitoring slot(s) for the group 2 SS is determined based on a synchronization signal block (SSB) index or an SSB candidate index of an SSB that the terminal receives from the base station.

7. The control channel reception method according to claim 6, wherein when the PDCCH monitoring slot(s) for the group 2 SS are two slots, a position of a first slot among the two slots is determined based on the SSB index or the SSB candidate index, and a position of a second slot among the two slots is determined by applying a predetermined offset to the position of the first slot.

8. The control channel reception method according to claim 4, further comprising receiving a first parameter and a second parameter from the base station, wherein the first parameter is a bitmap indicating the PDCCH monitoring slot(s) among the slot(s) constituting the one slot span, and the second parameter is a bitmap indicating positions(s) of symbol(s) from which a search space starts in each of the PDCCH monitoring slot(s).

9. The control channel reception method according to claim 1, wherein each of the at least one slot span combination is applied to all types of slot(s) regardless of uplink (UL)/downlink (DL) configuration, or applied to slot(s) having DL symbols and/or flexible symbols equal to or more than a specific threshold.

10. A control channel transmission method performed by a base station, comprising:
receiving, from a terminal, information on at least one slot span combination supportable by the terminal for physical downlink control channel (PDCCH) monitoring;
configuring PDCCH occasion(s) for PDCCH(s) to be transmitted to the terminal based on the at least one slot span combination supportable by the terminal; and
transmitting PDCCH(s) in the configured PDCCH occasion(s).

11. The control channel transmission method according to claim 10, wherein the information on at least one slot span combination supportable by the terminal for PDCCH monitoring is reported for each of subcarrier spacings supported by the terminal.

12. The control channel transmission method according to claim 11, wherein when the terminal operates in a frequency band of 52.6 GHz or above, the sub-carrier spacings include 480 kHz and 960 kHz subcarrier spacings.

13. The control channel transmission method according to claim 10, wherein each of the at least one slot span combination is indicated by (X, Y), X indicates a number of slot(s) constituting one slot span, and Y indicates a number of PDCCH monitoring slot(s) included in one slot span.

14. The control channel transmission method according to claim 10, wherein each of the at least one slot span combination is indicated by (X, Y), X indicates a number of slot(s) constituting one slot span, and Y is determined based on a number of PDCCH monitoring slot(s) for a group 1 search space (SS) and/or a number of PDCCH monitoring slot(s) for a group 2 search space (SS), the group 1 SS and the group 2 SS being included in the one slot span.

15. The control channel transmission method according to claim 14, wherein a position of the PDCCH monitoring slot(s) for the group 2 SS is determined based on a synchronization signal block (SSB) index or an SSB candidate index of an SSB that the base station transmits to the terminal.

16. The control channel transmission method according to claim 15, wherein when the PDCCH monitoring slot(s) for the group 2 SS are two slots, a position of a first slot among the two slots is determined based on the SSB index or the SSB candidate index, and a position of a second slot among the two slots is determined by applying a predetermined offset to the position of the first slot.

17. The control channel transmission method according to claim 13, further comprising transmitting a first parameter and a second parameter to the terminal, wherein the first parameter is a bitmap indicating the PDCCH monitoring slot(s) among the slot(s) constituting the one slot span, and the second parameter is a bitmap indicating positions(s) of symbol(s) from which a search space starts in each of the PDCCH monitoring slot(s).

18. The control channel transmission method according to claim 10, wherein each of the at least one slot span combination is applied to all types of slot(s) regardless of uplink (UL)/downlink (DL) configuration, or applied to slot(s) having DL symbols and/or flexible symbols equal to or more than a specific threshold.

19. A terminal in a communication system, comprising:
a processor; and
a transceiver controlled by the processor, wherein the processor causes the terminal to:
report, to a base station and through the transceiver, information on at least one slot span combination supportable by the terminal for physical downlink control channel (PDCCH) monitoring;
identify PDCCH occasion(s) for PDCCH(s) to be transmitted from the base station based on the at least one slot span combination supportable by the terminal; and
perform PDCCH monitoring by using the transceiver in the identified PDCCH occasion(s).

20. The terminal according to claim 19, wherein the information on at least one slot span combination supportable by the terminal for PDCCH monitoring is reported for each of subcarrier spacings supported by the terminal, and when the terminal operates in a frequency band of 52.6 GHz or above, the sub-carrier spacings include 480 kHz and 960 kHz subcarrier spacings.
